(19) United States
(12) Patent Application Publication
(10) Pub. No.: US 2024/0040122 A1
(43) Pub. Date: Feb. 1, 2024

(54) Transforms and Sign Prediction

(71) Applicants: Beijing Bytedance Network Technology Co., Ltd., Beijing (CN); Bytedance Inc., Los Angeles, CA (US)

(72) Inventors: Kai Zhang, San Diego, CA (US); Li Zhang, San Diego, CA (US); Zhipin Deng, Beijing (CN)

(21) Appl. No.: 18/485,531

(22) Filed: Oct. 12, 2023

Related U.S. Application Data
(63) Continuation of application No. PCT/CN2022/086236, filed on Apr. 12, 2022.

(30) Foreign Application Priority Data
Apr. 12, 2021 (WO) PCT/CN2021/086535

(51) Int. Cl. H04N 19/122; H04N 19/61; H04N 19/96; H04N 19/18; H04N 19/176

(52) U.S. Cl. CPC H04N 19/122; H04N 19/61; H04N 19/96; H04N 19/18; H04N 19/176

(57) ABSTRACT

A mechanism for processing video data is disclosed. A sign prediction usage for one or more residual coefficients in a block is determined based on dimensions of the block. A conversion is then performed between a visual media data and a bitstream based on the residual coefficients in the block.

### CROSS-REFERENCE TO RELATED APPLICATIONS

This application is a continuation of International Patent Application No. PCT/CN2022/086236, filed on Apr. 12, 2022, which claims the benefit of International Patent Application No. PCT/CN2021/086535, filed on Apr. 12, 2021. All the aforementioned patent applications are hereby incorporated by reference in their entireties.

### TECHNICAL FIELD

This patent document relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video data comprising: determining, for a conversion between a block of a video and a bitstream of the video, sign prediction usage for one or more residual coefficients in the block based on dimensions of the block; and performing the conversion based on the residual coefficients in the block.

Optionally, in any of the preceding aspects, another implementation of the aspect provides that sign prediction is disallowed for the block when the block is non-dyadic.

Optionally, in any of the preceding aspects, another implementation of the aspect provides that sign prediction is applied to a dyadic sized set of the residual coefficients in the block when the block is non-dyadic.

Optionally, in any of the preceding aspects, another implementation of the aspect provides that sign prediction is disallowed for the block when a dimension of the block is not evenly divisible by M, where M is an integer value.

Optionally, in any of the preceding aspects, another implementation of the aspect provides that sign prediction is disallowed for the block when a dimension of the block is equal to M, where M is an integer value.

Optionally, in any of the preceding aspects, another implementation of the aspect provides that a syntax element describing sign prediction for the block is omitted from the bitstream when sign prediction is disallowed for the block.

Optionally, in any of the preceding aspects, another implementation of the aspect provides determining a set of hypothesis reconstructed sample values for the block based on a prediction hypothesis, wherein the block has dimensions including a width (W) and a height (H).

Optionally, in any of the preceding aspects, another implementation of the aspect provides that at least one of W or H is non-dyadic.

Optionally, in any of the preceding aspects, another implementation of the aspect provides that the set hypothesis reconstructed sample values for the block is determined based on a pattern of the residual coefficients in the block.

Optionally, in any of the preceding aspects, another implementation of the aspect provides determining the set of hypothesis reconstructed sample values includes determining a first set of hypothesis reconstructed sample values and determining a second set of hypothesis reconstructed sample values, and wherein each set of hypothesis reconstructed sample values correspond to a specific residual coefficient.

Optionally, in any of the preceding aspects, another implementation of the aspect provides that the first set of hypothesis reconstructed sample values and the second set of hypothesis reconstructed sample values are collectively used to determine a cost for the pattern of the residual coefficients in the block.

Optionally, in any of the preceding aspects, another implementation of the aspect provides that a first table stores all sets of hypothesis reconstructed sample values in entries, and wherein a second table indicates indices for the entries in the first table.

Optionally, in any of the preceding aspects, another implementation of the aspect provides determining sign information for the residual coefficients in the block based on the sets of hypothesis reconstructed sample values.

Optionally, in any of the preceding aspects, another implementation of the aspect provides that the block includes a first sign and a second sign, and wherein the first sign is predicted according to a first rule and the second sign is predicted according to a second rule that is different from the first rule.

Optionally, in any of the preceding aspects, another implementation of the aspect provides that the block includes a first sign and a second sign, and wherein a prediction of the second sign is dependent of a prediction of the first sign.

Optionally, in any of the preceding aspects, another implementation of the aspect provides that a maximum number of predicted signs is determined based on a location of the block, a block dimension, a block type, or combinations thereof.

Optionally, in any of the preceding aspects, another implementation of the aspect provides that sign prediction is determined based on coding information including a quantization parameter (QP), a prediction mode, a coding tool, motion information, a color component, a color format, a temporal layer, a slice type, a neighboring block information, a coding tree depth, the residual coefficients of the block, a transform type, a residual coding mode, a partition tree type, or combinations thereof.

Optionally, in any of the preceding aspects, another implementation of the aspect provides determining whether to signal a low frequency non-separable secondary transform (LFNST) index based on a first variable, wherein the first variable is modified by at least one of color component of the block, coding structure of the block, or block type of the block.

Optionally, in any of the preceding aspects, another implementation of the aspect provides that the first variable is a LFNST direct current (DC) only (LfnstDcOnly) flag or a LFNST zero out sign coefficient flag (LfnstZeroOutSigCoeffFlag).

Optionally, in any of the preceding aspects, another implementation of the aspect provides that the first variable is dependent on a transform skip flag.

Optionally, in any of the preceding aspects, another implementation of the aspect provides that the first variable is not modified when parsing a residual block of a first color component when single-tree coding structure is applied.

Optionally, in any of the preceding aspects, another implementation of the aspect provides that the first variable is modified when parsing a residual block of a first color component when a dual-tree coding structure is applied.

Optionally, in any of the preceding aspects, another implementation of the aspect provides that the first variable is modified when parsing a residual block of a first color component when a dual-tree coding structure is applied.

Optionally, in any of the preceding aspects, another implementation of the aspect provides that the determination whether to signal the LFNST index is based on a modified value in the first variable.

Optionally, in any of the preceding aspects, another implementation of the aspect provides that the conversion includes encoding the block into the bitstream.

Optionally, in any of the preceding aspects, another implementation of the aspect provides that the conversion includes decoding the block from the bitstream.

A second aspect relates to a non-transitory computer readable medium comprising a computer program product for use by a video coding device, the computer program product comprising computer executable instructions stored on the non-transitory computer readable medium such that when executed by a processor cause the video coding device to perform the method of any of the preceding aspects.

A third aspect relates to an apparatus for processing video data comprising: a processor; and a non-transitory memory with instructions thereon, wherein the instructions upon execution by the processor, cause the processor to perform the method of any of the preceding aspects.

A fourth aspect relates to a non-transitory computer-readable recording medium storing a bitstream of a video which is generated by a method performed by a video processing apparatus, wherein the method comprises: determining sign prediction usage for one or more residual coefficients in a block based on dimensions of the block; and generating the bitstream based on the determining.

A fifth aspect relates to a method for storing bitstream of a video, comprising: determining sign prediction usage for one or more residual coefficients in a block based on dimensions of the block; generating the bitstream based on the determining; and storing the bitstream in a non-transitory computer-readable recording medium.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an example Non-Separable Secondary Transform (NSST) process.

FIG. 2 is a schematic diagram of an example reduced secondary transform (RST) process.

FIG. 3 is a schematic diagram of another example of residual transformation.

FIG. 4 is a schematic diagram of an example luma block and a corresponding chroma block.

FIG. 5 is a schematic diagram of an example forward LFNTS 8×8 process with a 16×48 matrix.

FIG. 6 is a schematic diagram of example ¼ Unsymmetric Binary Tree (UBT) partitioning structures.

FIG. 7 is a schematic diagram of a mechanism for determining costs for a sign prediction hypothesis at a reconstructed border.

FIG. 8 is a block diagram showing an example video processing system.

FIG. 9 is a block diagram of an example video processing apparatus.

FIG. 10 is a flowchart for an example method of video processing.

FIG. 11 is a block diagram that illustrates an example video coding system.

FIG. 12 is a block diagram that illustrates an example encoder.

FIG. 13 is a block diagram that illustrates an example decoder.

FIG. 14 is a schematic diagram of an example encoder.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

This document is related to video coding technologies, and more particularly to transforms and sign prediction in video coding. The disclosed mechanisms may be applied to the video coding standards such as High Efficiency Video Coding (HEVC) and/or Versatile Video Coding (VVC). Such mechanisms may also be applicable to other image/video coding standards and/or video codecs.

Video coding standards have evolved primarily through the development of the International Telecommunication Union (ITU) Telecommunication Standardization Sector (ITU-T) and International Organization for Standardization (ISO)/International Electrotechnical Commission (IEC) standards. The ITU-T produced a H.261 standard and a H.263 standard, ISO/IEC produced Motion Picture Experts Group (MPEG) phase one (MPEG-1) and MPEG phase four (MPEG-4) Visual standards, and the two organizations jointly produced the H.262/MPEG phase two (MPEG-2) Video standard, the H.264/MPEG-4 Advanced Video Coding (AVC) standard, and the H.265/High Efficiency Video Coding (HEVC) standard. Since H.262, the video coding standards are based on a hybrid video coding structure that utilizes a temporal prediction plus a transform coding. To explore video coding technologies beyond HEVC, the Joint Video Exploration Team (JVET) was jointly founded by VCEG and MPEG. Further, methods have been adopted by JVET and included into a reference software known as Joint Exploration Model (JEM). The JVET announced VVC, which is coding standard is targeting at fifty percent bitrate reduction as compared to HEVC. The VVC employs a VVC test model (VTM).

The present disclosure relates to video coding. In video coding, pictures are partitioned into blocks. The blocks are matched to reference blocks. This allows an encoder to encode a block by reference to a reference block according to a process called prediction. Prediction can include matching to reference blocks in the same picture and matching to reference blocks in different picture(s), known as intra prediction and inter prediction, respectively. Any difference between a current block and a reference block is known as residual, residual data, and/or residue. The encoder encodes both the prediction and the residual into a bitstream. In order to reconstruct a current block, a decoder obtains the prediction and residual data from the bitstream and, adds the prediction to the residual data. More specifically, an encoder can code the residual data by applying a transform to the residual. This converts the residual data from samples (e.g., pixel values) to coefficients. The encoder can also apply quantization to remove certain coefficients from the transformed residual data. Quantization applies further compression at the cost of losing some residual data. The encoder can then encode the transformed and quantized residual into the bitstream. At the decoder, the residual is obtained from the bitstream and dequantized. An inverse transform is also applied in order to reconstruct the residual data. The decoder can then reconstruct a block by applying the reconstructed residual data. The present disclosure relates to the process of transforming residual for use in conjunction with prediction for code and decode blocks of pictures in video.

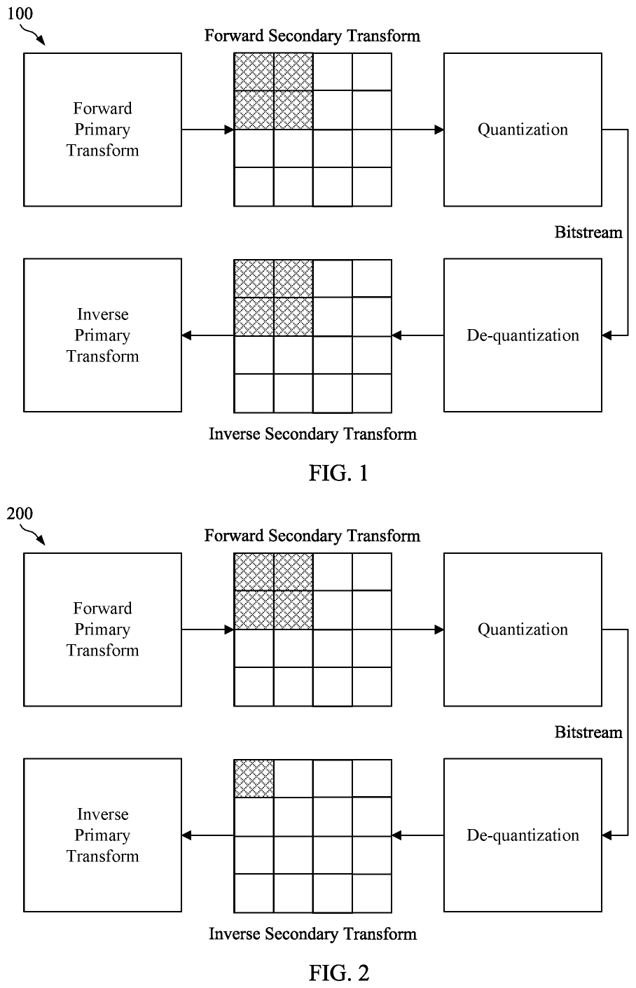

FIG. 1 is a schematic diagram 100 of an example Non-Separable Secondary Transform (NSST) process, as applied in JEM. At an encoder, a forward primary transform is applied to a block of residual data. Then a secondary transform is applied prior to quantization. The result is coded into the bitstream. At the decoder, de-quantization is performed. Then an inverse secondary transform is applied prior to application of an inverse primary transform, which reconstructs the residual for use in decoding the block. In schematic diagram 100, a 4×4 or 8×8 secondary transform is performed depending on the block size. For example, a 4×4 secondary transform is applied for small blocks (e.g., min (width, height) <8) and 8×8 secondary transform is applied for larger blocks (e.g., min (width, height) >4) per 8×8 block.

Application of a non-separable transform is described as follows using input as an example. To apply the non-separable transform, the 4×4 input block X:

$$X = [ \begin{matrix}{X}_{00} & {X}_{01} & {X}_{02} & {X}_{03} \\ {X}_{10} & {X}_{11} & {X}_{12} & {X}_{13} \\ {X}_{20} & {X}_{21} & {X}_{22} & {X}_{23} \\ {X}_{30} & {X}_{31} & {X}_{32} & {X}_{33}\end{matrix} ]$$

is first represented as a vector [symbol] as follows:

[symbol]

=

[X₀₀ X₀₁ X₀₂ X₀₃ X₁₀ X₁₁ X₁₂ X₁₃ X₂₀ X₂₁ X₂₂ X₂₃ X₃₀ X₃₁ X₃₂ X₃₃]^{T}

The non-separable transform is calculated as [symbol] =T· [symbol] , where [symbol] indicates the transform coefficient vector, and T is a 16×16 transform matrix. The 16×1 coefficient vector [symbol] is subsequently re-organized as 4×4 block using the scanning order for that block (horizontal, vertical, or diagonal). The coefficients with smaller index are placed with the smaller scanning index in the 4×4 coefficient block. There are 35 transform sets in total, and three non-separable transform matrices (kernels) per transform set are used. The mapping from the intra prediction mode to the transform set is pre-defined. For each transform set, the selected non-separable secondary transform candidate is further specified by the explicitly signaled secondary transform index. The index is signaled in a bit-stream once per intra CU after transform coefficients.

A reduced secondary transform (RST), also known as a low frequency non-separable transform (LFNST) is now discussed. The RST may employ a four transform set (instead of 35 transform sets). 16×64 (may be further reduced to 16×48) and 16×16 matrices are employed for 8×8 and 4×4 blocks, respectively. For notational convenience, the 16×64 (may further be reduced to 16×48) transform is denoted as RST8×8 and the 16×16 one as RST4×4.

FIG. 2 is a schematic diagram 200 of an example RST process that employs a reduced secondary transform. At an encoder, a forward primary transform is applied to a block of residual data. Then a secondary transform is applied prior to quantization. The result is coded into the bitstream. At the decoder, de-quantization is performed. Then an inverse secondary transform is applied prior to application of an inverse primary transform, which reconstructs the residual for use in decoding the block. In schematic diagram 200, 16 coefficients result from a 4×4 forward reduced secondary transform, and 64 coefficients result from a 8×8 forward reduced secondary transform. Further, a 4×4 or an 8×8 inverse reduced secondary transform is applied to 8 or 16 coefficients, respectively.

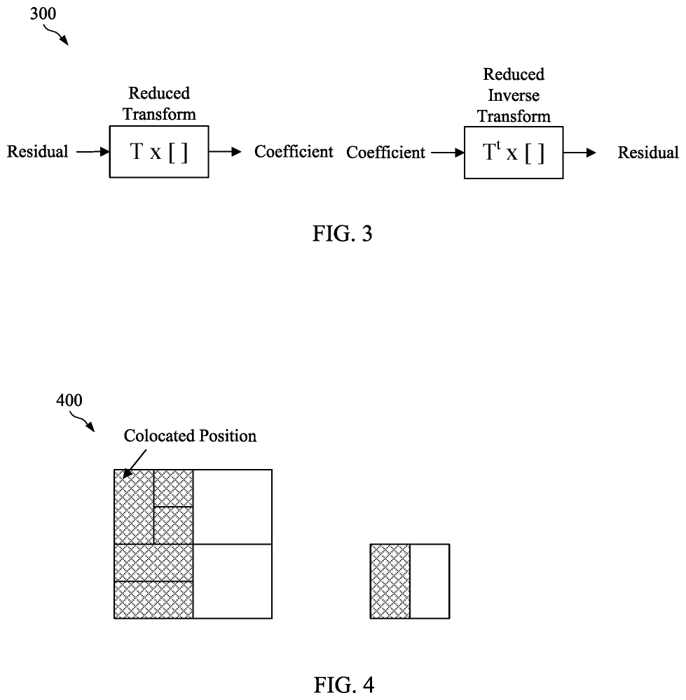

RST computation is now discussed. The idea of a Reduced Transform (RT) is to map an N dimensional vector to an R dimensional vector in a different space, where R/N (R<N) is the reduction factor. The RT matrix is an R×N matrix as follows:

$${T}_{RxN} = [ \begin{matrix}{t}_{11} & {t}_{12} & {t}_{13} & ⋯ & {t}_{1 N} \\ {t}_{21} & {t}_{22} & {t}_{23} & ⋯ & {t}_{2 N} \\ ⋮ & ⋮ & ⋮ & ⋱ & ⋮ \\ {t}_{R 1} & {t}_{R 2} & {t}_{R 3} & ⋯ & {t}_{RN}\end{matrix} ]$$

where the R rows of the transform are R bases of the N dimensional space. The inverse transform matrix for RT is the transpose of the corresponding forward transform. The forward and inverse RT are depicted in FIG. 3.

FIG. 3 is a schematic diagram 300 of another example of residual transformation, for example as used in VVC. The residual can be transformed by a reduced transform T and quantized at an encoder to creates coefficients, which represent the residual data in a compressed form. A dequantization and inverse transform T^{t} with a reduced inverse transform can be applied at a decoder to convert the coefficients back into the residual data. The residual data can then be applied to the prediction to reconstruct the coded block for display.

In an example, the RST 8×8 with a reduction factor of 4 (¼ size) is applied. Hence, instead of 64×64, which results from a 8×8 non-separable transform matrix size, a 16×64 direct matrix is used. In other words, the 64×16 inverse RST matrix is used at the decoder side to generate core (primary) transform coefficients in the 8×8 top-left regions. The forward RST8×8 uses 16×64 (or 8×64 for 8×8 block) matrices so that the transform produces non-zero coefficients only in the top-left 4×4 region within the given 8×8 region. In other words, when RST is applied the 8×8 region except the top-left 4×4 region has only zero coefficients. For RST4×4, 16×16 (or 8×16 for 4×4 block) direct matrix multiplication is applied.

An inverse RST is conditionally applied when the following two conditions are satisfied: block size is greater than or equal to the given threshold (W>=4 && H>=4); and transform skip mode flag is equal to zero. If both W and H of a transform coefficient block is greater than 4, then the RST8×8 is applied to the top-left 8×8 region of the transform coefficient block. Otherwise, the RST4×4 is applied on the top-left min(8, W)×min(8, H) region of the transform coefficient block. If RST index is equal to 0, RST is not applied. Otherwise, RST is applied, with a kernel chosen based on the RST index. The RST selection method and coding of the RST index are explained below. Furthermore, RST is applied for intra CUs, in both intra and inter slices, and for both luma and chroma components. If a dual tree is enabled, RST indices for luma and chroma components are signaled separately. For inter slice (the dual tree is disabled), a single RST index is signaled and used for both luma and chroma components.

Intra Sub-Partitions (ISP) is an example intra prediction mode. When ISP mode is selected, RST is disabled and the RST index is not signaled. This is because performance improvements are marginal even when RST is applied to every feasible partition block in this case. Furthermore, disabling RST for ISP-predicted residual reduces encoding complexity.

RST selection is now discussed. A RST matrix is chosen from four transform sets, each of which comprises two transforms. Which transform set is applied is determined from intra prediction mode as the follows. When one of three CCLM modes is indicated, transform set 0 is selected. Otherwise, the transform set selection is performed according to the table below.

| IntraPredMode | Transform set index |
|---|---|
| IntraPredMode < 0 | 1 |
| 0 <= IntraPredMode <= 1 | 0 |
| 2 <= IntraPredMode <= 12 | 1 |
| 13 <= IntraPredMode <= 23 | 2 |
| 24 <= IntraPredMode <= 44 | 3 |
| 45 <= IntraPredMode <= 55 | 2 |
| 56 <= IntraPredMode | 1 |

The indices to access the Table, denoted as IntraPredMode, have a range of [−14, 83], which is a transformed mode index used for wide angle intra predictions.

Further, the RST set selection for chroma blocks coded in CCLM mode can be modified to be based on a variable intra prediction mode cross component linear model (IntraPredMode_CCLM). The IntraPredMode_CCLM has a range of [−14, 80]. The IntraPredMode_CCLM is determined by the co-located luma intra prediction mode and the dimension of the current chroma block.

FIG. 4 is a schematic diagram 400 of an example luma block, on the left, and a corresponding chroma block, on the right, split by a dual tree partition. When dual tree is enabled, the block (e.g., prediction unit (PU)) covering the corresponding luma sample of the top-left chroma sample in the current chroma block is defined as the co-located luma block. Schematic diagram 400 shows such an example with a co-located position denoted at the top left corner of the luma block.

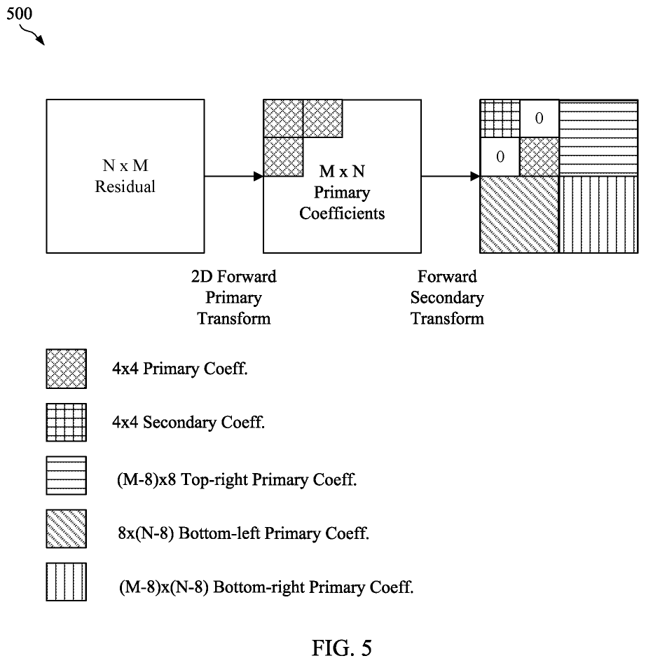

RST matrices of reduced dimension is now discussed. FIG. 5 is a schematic diagram 500 of an example forward LFNTS 8×8 process with a 16×48 matrix. As shown, a block of N×M residual (where N and M are greater than or equal to 8) is obtained as a difference between a prediction block and a current block. A two dimensional (2D) forward primary transform is applied to the N×M residual to create a block of M×N primary coefficients. Reference is particularly made to the top left corner coefficients from the block of M×N primary coefficients. These coefficients are grouped in three blocks of 4×4 primary coefficients. In contrast with other processes, application of the secondary transform includes application of 16×48 matrices instead of 16×64 with the same transform set configuration, denoted as the kernel. Each of the matrices takes a 48×1 vector as input data. The 48×1 vector is created from three blocks of 4×4 primary coefficients from the top-left 8×8 block from the M×N primary coefficients. This excludes the right-bottom 4×4 block as shown in schematic diagram 500. Accordingly, application of the forward secondary transform results in a 4×4 block of secondary coefficients, two 4×4 blocks of zero coefficients, a M−8×8 block of top-right primary coefficients, a 8×(N−8) block of bottom-left primary coefficients, and a block of (M−8)×(N−8) bottom-right primary coefficients. The 4×4 block of secondary coefficients is generated from a 16×1 vector created by applying the 16×48 matrices to the 48×1 vector from the top left group of 4×4 primary coefficients.

Low frequency non-separable transform (LFNST) as used in VVC is developed from RST. An example of LFNST coding syntax as used in VVC is as follows.

| | Descriptor |
|---|---|
| coding_unit( x0, y0, cbWidth, cbHeight, cqtDepth, treeType, modeType ) { | |
| if( sh_slice_type = = I && ( cbWidth > 64 \| \| cbHeight > 64 ) ) | |
| modeType = MODE_TYPE_INTRA | |
| chType = treeType = = DUAL_TREE_CHROMA ? 1 : 0 | |
| if( sh_slice_type != I \| \| sps_ibc_enabled_flag ) { | |
| if( treeType != DUAL_TREE_CHROMA && | |
| ( ( !( cbWidth = = 4 && cbHeight = = 4 ) && | |
| modeType != MODE_TYPE_INTRA ) \| \| | |
| ( sps_ibc_enabled_flag && cbWidth <= 64 && cbHeight <= 64 ) ) ) | |
| cu_skip_flag[ x0 ][ y0 ] | ae(v) |
| if( cu_skip_flag[ x0 ][ y0 ] = = 0 && sh_slice_type != I && | |
| !( cbWidth = = 4 && cbHeight = = 4 ) && modeType = = | |
| MODE_TYPE_ALL ) | |
| pred_mode_flag | ae(v) |
| if( ( ( sh_slice_type = = I && cu_skip_flag[ x0 ][ y0 ] = =0 ) \| \| | |
| ( sh_slice_type != I && ( CuPredMode[ chType ][ x0 ][ y0 ] != | |
| MODE_INTRA \| \| | |
| ( ( ( cbWidth = = 4 && cbHeight = = 4 ) \| \| modeType = = | |
| MODE_TYPE_INTRA ) | |
| && cu_skip_flag[ x0 ][ y0 ] = = 0 ) ) ) ) && | |
| cbWidth <= 64 && cbHeight <= 64 && modeType != | |
| MODE_TYPE_INTER && | |
| sps_ibc_enabled_flag && treeType != DUAL_TREE_CHROMA ) | |
| pred_mode_ibc_flag | ae(v) |
| } | |
| if( CuPredMode[ chType ][ x0 ][ y0 ] = = MODE_INTRA && | |
| sps_palette_enabled_flag && | |
| cbWidth <= 64 && cbHeight <= 64 && cu_skip_flag[ x0 ][ y0 ] = = 0 | |
| && | |
| modeType != MODE_TYPE_INTER && ( ( cbWidth * cbHeight ) > | |
| ( treeType != DUAL_TREE_CHROMA ? 16 : 16 * SubWidthC * SubHeightC | |
| ) ) && | |
| ( modeType != MODE_TYPE_INTRA \| \| treeType != | |
| DUAL_TREE_CHROMA ) ) | |
| pred_mode_plt_flag | ae(v) |
| if( CuPredMode[ chType ][ x0 ][ y0 ] = = MODE_INTRA && | |
| sps_act_enabled_flag && | |
| treeType = = SINGLE_TREE ) | |
| cu_act_enabled_flag | ae(v) |
| if( CuPredMode[ chType ][ x0 ][ y0 ] = = MODE_INTRA \| \| | |
| CuPredMode[ chType ][ x0 ][ y0 ] = = MODE_PLT ) { | |
| if( treeType = = SINGLE_TREE \| \| treeType = = DUAL_TREE_LUMA ) { | |
| if( pred_mode_plt_flag ) | |
| palette_coding( x0, y0, cbWidth, cbHeight, treeType ) | |
| else { | |
| if( sps_bdpcm_enabled_flag && | |
| cbWidth <= MaxTsSize && cbHeight <= MaxTsSize ) | |
| intra_bdpcm_luma_flag | ae(v) |
| if( intra_bdpcm_luma_flag ) | |
| intra_bdpcm_luma_dir_flag | ae(v) |
| else { | |
| if( sps_mip_enabled_flag ) | |
| intra_mip_flag | ae(v) |
| if( intra_mip_flag ) { | |
| intra_mip_transposed_flag[ x0 ][ y0 ] | ae(v) |
| intra_mip_mode[ x0 ][ y0 ] | ae(v) |
| } else { | |
| if( sps_mrl_enabled_flag && ( ( y0 % CtbSizeY ) > 0 ) ) | |
| intra_luma_ref_idx | ae(v) |
| if( sps_isp_enabled_flag && intra_luma_ref_idx = = 0 && | |
| ( cbWidth <= MaxTbSizeY && cbHeight <= MaxTbSizeY ) | |
| && | |
| ( cbWidth * cbHeight > MinTbSizeY * MinTbSizeY ) && | |
| !cu_act_enabled_flag ) | |
| intra_subpartitions_mode_flag | ae(v) |
| if( intra_subpartitions_mode_flag = = 1 ) | |
| intra_subpartitions_split_flag | ae(v) |
| if( intra_luma_ref_idx = = 0 ) | |
| intra_luma_mpm_flag[ x0 ][ y0 ] | ae(v) |
| if( intra_luma_mpm_flag[ x0 ][ y0 ] ) { | |
| if( intra_luma_ref_idx = = 0 ) | |
| intra_luma_not_planar_flag[ x0 ][ y0 ] | ae(v) |
| if( intra_luma_not_planar_flag[ x0 ][ y0 ] ) | |
| intra_luma_mpm_idx[ x0 ][ y0 ] | ae(v) |
| } else | |
| intra_luma_mpm_remainder[ x0 ][ y0 ] | ae(v) |
| } | |
| } | |
| } | |
| } | |
| if( ( treeType = = SINGLE_TREE \| \| treeType = = DUAL_TREE_CHROMA ) | |
| && | |
| sps_chroma_format_idc != 0 ) { | |
| if( pred_mode_plt_flag && treeType = = DUAL_TREE_CHROMA ) | |
| palette_coding( x0, y0, cbWidth / SubWidthC, cbHeight / SubHeightC, | |
| treeType ) | |
| else if( !pred_mode_plt_flag ) { | |
| if( !cu_act_enabled_flag ) { | |
| if( cbWidth / SubWidthC <= MaxTsSize && cbHeight / SubHeightC <= | |
| MaxTsSize | |
| && sps_bdpcm_enabled_flag ) | |
| intra_bdpcm_chroma_flag | ae(v) |
| if( intra_bdpcm_chroma_flag ) | |
| intra_bdpcm_chroma_dir_flag | ae(v) |
| else { | |
| if( CclmEnabled ) | |
| cclm_mode_flag | ae(v) |
| if( cclm_mode_flag ) | |
| cclm_mode_idx | ae(v) |
| else | |
| intra_chroma_pred_mode | ae(v) |
| } | |
| } | |
| } | |
| } | |
| } else if( treeType != DUAL_TREE_CHROMA ) { /* MODE_INTER or | |
| MODE_IBC */ | |
| if( cu_skip_flag[ x0 ][ y0 ] = = 0 ) | |
| general_merge_flag[ x0 ][ y0 ] | ae(v) |
| if( general_merge_flag[ x0 ][ y0 ] ) | |
| merge_data( x0, y0, cbWidth, cbHeight, chType ) | |
| else if( CuPredMode[ chType ][ x0 ][ y0 ] = = MODE_IBC ) { | |
| mvd_coding( x0, y0, 0, 0 ) | |
| if( MaxNumIbcMergeCand > 1 ) | |
| mvp_l0_flag[ x0 ][ y0 ] | ae(v) |
| if( sps_amvr_enabled_flag && | |
| ( MvdL0[ x0 ][ y0 ][ 0 ] != 0 \| \| MvdL0[ x0 ][ y0 ][ 1 ] != 0 ) ) | |
| amvr_precision_idx[ x0 ][ y0 ] | ae(v) |
| } else { | |
| if( sh_slice_type = = B ) | |
| inter_pred_idc[ x0 ][ y0 ] | ae(v) |
| if( sps_affine_enabled_flag && cbWidth >= 16 && cbHeight >= 16 ) { | |
| inter_affine_flag[ x0 ][ y0 ] | ae(v) |
| if( sps_6param_affine_enabled_flag && inter_affine_flag[ x0 ][ y0 ] ) | |
| cu_affine_type_flag[ x0 ][ y0 ] | ae(v) |
| } | |
| if( sps_smvd_enabled_flag && !ph_mvd_l1_zero_flag && | |
| inter_pred_idc[ x0 ][ y0 ] = = PRED_BI && | |
| !inter_affine_flag[ x0 ][ y0 ] && RefIdxSymL0 > −1 && RefIdxSymL1 | |
| > −1 ) | |
| sym_mvd_flag[ x0 ][ y0 ] | ae(v) |
| if( inter_pred_idc[ x0 ][ y0 ] != PRED_L1 ) { | |
| if( NumRefIdxActive[ 0 ] > 1 && !sym_mvd_flag[ x0 ][ y0 ] ) | |
| ref_idx_l0[ x0 ][ y0 ] | ae(v) |
| mvd_coding( x0, y0, 0, 0 ) | |
| if( MotionModelIdc[ x0 ][ y0 ] > 0 ) | |
| mvd_coding( x0, y0, 0, 1 ) | |
| if(MotionModelIdc[ x0 ][ y0 ] > 1 ) | |
| mvd_coding( x0, y0, 0, 2 ) | |
| mvp_l0_flag[ x0 ][ y0 ] | ae(v) |
| } else { | |
| MvdL0[ x0 ][ y0 ][ 0 ] = 0 | |
| MvdL0[ x0 ][ y0 ][ 1 ] = 0 | |
| } | |
| if( inter_pred_idc[ x0 ][ y0 ] != PRED_L0 ) { | |
| if( NumRefIdxActive[ 1 ] > 1 && !sym_mvd_flag[ x0 ][ y0 ] ) | |
| ref_idx_l1[ x0 ][ y0 ] | ae(v) |
| if( ph_mvd_l1_zero_flag && inter_pred_idc[ x0 ][ y0 ] = = PRED_BI ) { | |
| MvdL1[ x0 ][ y0 ][ 0 ] = 0 | |
| MvdL1[ x0 ][ y0 ][ 1 ] = 0 | |
| MvdCpL1[ x0 ][ y0 ][ 0 ][ 0 ] = 0 | |
| MvdCpL1[ x0 ][ y0 ][ 0 ][ 1 ] = 0 | |
| MvdCpL1[ x0 ][ y0 ][ 1 ][ 0 ] = 0 | |
| MvdCpL1[ x0 ][ y0 ][ 1 ][ 1 ] = 0 | |
| MvdCpL1[ x0 ][ y0 ][ 2 ][ 0 ] = 0 | |
| MvdCpL1[ x0 ][ y0 ][ 2 ][ 1 ] = 0 | |
| } else { | |
| if( sym_mvd_flag[ x0 ][ y0 ] ) { | |
| MvdL1[ x0 ][ y0 ][ 0 ] = −MvdL0[ x0 ][ y0 ][ 0 ] | |
| MvdL1[ x0 ][ y0 ][ 1 ] = −MvdL0[ x0 ][ y0 ][ 1 ] | |
| } else | |
| mvd_coding( x0, y0, 1, 0 ) | |
| if( MotionModelIdc[ x0 ][ y0 ] > 0 ) | |
| mvd_coding( x0, y0, 1, 1 ) | |
| if(MotionModelIdc[ x0 ][ y0 ] > 1 ) | |
| mvd_coding( x0, y0, 1, 2 ) | |
| } | |
| mvp_l1_flag[ x0 ][ y0 ] | ae(v) |
| } else { | |
| MvdL1[ x0 ][ y0 ][ 0 ] = 0 | |
| MvdL1[ x0 ][ y0 ][ 1 ] = 0 | |
| } | |
| if( ( sps_amvr_enabled_flag && inter_affine_flag[ x0 ][ y0 ] = = 0 && | |
| ( MvdL0[ x0 ][ y0 ][ 0 ] != 0 \| \| MvdL0[ x0 ][ y0 ][ 1 ] != 0 \| \| | |
| MvdL1[ x0 ][ y0 ][ 0 ] != 0 \| \| MvdL1[ x0 ][ y0 ][ 1 ] != 0 ) ) \| \| | |
| ( sps_affine_amvr_enabled_flag && inter_affine_flag[ x0 ][ y0 ] = = 1 | |
| && | |
| ( MvdCpL0[ x0 ][ y0 ][ 0 ][ 0 ] != 0 \| \| MvdCpL0[ x0 ][ y0 ][ 0 ][ 1 ] != | |
| 0 \| \| | |
| MvdCpL1[ x0 ][ y0 ][ 0 ][ 0 ] != 0 \| \| MvdCpL1[ x0 ][ y0 ][ 0 ][ 1 ] != 0 | |
| \| \| | |
| MvdCpL0[ x0 ][ y0 ][ 1 ][ 0 ] != 0 \| \| MvdCpL0[ x0 ][ y0 ][ 1 ][ 1 ] != 0 | |
| \| \| | |
| MvdCpL1[ x0 ][ y0 ][ 1 ][ 0 ] != 0 \| \| MvdCpL1[ x0 ][ y0 ][ 1 ][ 1 ] != 0 | |
| \| \| | |
| MvdCpL0[ x0 ][ y0 ][ 2 ][ 0 ] != 0 \| \| MvdCpL0[ x0 ][ y0 ][ 2 ][ 1 ] != 0 | |
| \| \| | |
| MvdCpL1[ x0 ][ y0 ][ 2 ][ 0 ] != 0 \| \| MvdCpL1[ x0 ][ y0 ][ 2 ][ 1 ] != | |
| 0 ) ) ) { | |
| amvr_flag[ x0 ][ y0 ] | ae(v) |
| if( amvr_flag[ x0 ][ y0 ] ) | |
| amvr_precision_idx[ x0 ][ y0 ] | ae(v) |
| } | |
| if( sps_bcw_enabled_flag && inter_pred_idc[ x0 ][ y0 ] = = PRED_BI && | |
| luma_weight_l0_flag[ ref_idx_l0 [ x0 ][ y0 ] ] = = 0 && | |
| luma_weight_l1_flag[ ref_idx_l1 [ x0 ][ y0 ] ] = = 0 && | |
| chroma_weight_l0_flag[ ref_idx_l0 [ x0 ][ y0 ] ] = = 0 && | |
| chroma_weight_l1_flag[ ref_idx_l1 [ x0 ][ y0 ] ] = = 0 && | |
| cbWidth * cbHeight >= 256 ) | |
| bcw_idx[ x0 ][ y0 ] | ae(v) |
| } | |
| } | |
| if( CuPredMode[ chType ][ x0 ][ y0 ] != MODE_INTRA && !pred_mode_plt_flag | |
| && | |
| general_merge_flag[ x0 ][ y0 ] = = 0 ) | |
| cu_coded_flag | ae(v) |
| if( cu_coded_flag ) { | |
| if( CuPredMode[ chType ][ x0 ][ y0 ] = = MODE_INTER && | |
| sps_sbt_enabled_flag && | |
| !ciip_flag[ x0 ][ y0 ] && cbWidth <= MaxTbSizeY && | |
| cbHeight <= MaxTbSizeY ) { | |
| allowSbtVerH = cbWidth >= 8 | |
| allowSbtVerQ = cbWidth >= 16 | |
| allowSbtHorH = cbHeight >= 8 | |
| allowSbtHorQ = cbHeight >= 16 | |
| if( allowSbtVerH \| \| allowSbtHorH ) | |
| cu_sbt_flag | ae(v) |
| if( cu_sbt_flag ) { | |
| if( ( allowSbtVerH \| \| allowSbtHorH ) && ( allowSbtVerQ \| \| | |
| allowSbtHorQ ) ) | |
| cu_sbt_quad_flag | ae(v) |
| if( ( cu_sbt_quad_flag && allowSbtVerQ && allowSbtHorQ ) \| \| | |
| ( !cu_sbt_quad_flag && allowSbtVerH && allowSbtHorH ) ) | |
| cu_sbt_horizontal_flag | ae(v) |
| cu_sbt_pos_flag | ae(v) |
| } | |
| } | |
| if( sps_act_enabled_flag && CuPredMode[ chType ][ x0 ][ y0 ] != | |
| MODE_INTRA && | |
| treeType = = SINGLE_TREE ) | |
| cu_act_enabled_flag | ae(v) |
| LfnstDcOnly = 1 | |
| LfnstZeroOutSigCoeffFlag = 1 | |
| MtsDcOnly = 1 | |
| MtsZeroOutSigCoeffFlag = 1 | |
| transform_tree( x0, y0, cbWidth, cbHeight, treeType, chType ) | |
| lfnstWidth = ( treeType = = DUAL_TREE_CHROMA ) ? cbWidth / SubWidthC : | |
| ( ( IntraSubPartitionsSplitType = = ISP_VER_SPLIT ) ? | |
| cbWidth / NumIntraSubPartitions : cbWidth ) | |
| lfnstHeight = ( treeType = = | |
| DUAL_TREE_CHROMA ) ? cbHeight / SubHeightC : | |
| ( ( IntraSubPartitionsSplitType = = ISP_HOR_SPLIT) ? | |
| cbHeight / NumIntraSubPartitions : cbHeight ) | |
| lfnstNotTsFlag = ( treeType = = DUAL_TREE_CHROMA \| \| | |
| !tu_y_coded_flag[ x0 ][ y0 ] \| \| | |
| transform_skip_flag[ x0 ][ y0 ][ 0 ] = = 0 ) && | |
| ( treeType = = DUAL_TREE_LUMA \| \| | |
| ( ( !tu_cb_coded_flag[ x0 ][ y0 ] \| \| | |
| transform_skip_flag[ x0 ][ y0 ][ 1 ] = = 0 ) && | |
| ( !tu_cr_coded_flag[ x0 ][ y0 ] \| \| | |
| transform_skip_flag[ x0 ][ y0 ][ 2 ] = = 0 ) ) ) | |
| if( Min( lfnstWidth, lfnstHeight ) >= 4 && sps_lfnst_enabled_flag = = 1 && | |
| CuPredMode[ chType ][ x0 ][ y0 ] = = MODE_INTRA && lfnstNotTsFlag | |
| = = 1 && | |
| ( treeType = = DUAL_TREE_CHROMA \| \| !IntraMipFlag[ x0 ][ y0 ] \| \| | |
| Min( lfnstWidth, lfnstHeight ) >= 16 ) && | |
| Max( cbWidth, cbHeight ) <= MaxTbSizeY) { | |
| if( ( IntraSubPartitionsSplitType != ISP_NO_SPLIT \| \| LfnstDcOnly = = 0 ) | |
| && | |
| LfnstZeroOutSigCoeffFlag = = 1 ) | |
| lfnst_idx | ae(v) |
| } | |
| if( treeType != DUAL_TREE_CHROMA && lfnst_idx = = 0 && | |
| transform_skip_flag[ x0 ][ y0 ][ 0 ] = = 0 && Max( cbWidth, cbHeight ) | |
| <= 32 && | |
| IntraSubPartitionsSplitType = = ISP_NO_SPLIT && cu_sbt_flag = = 0 | |
| && | |
| MtsZeroOutSigCoeffFlag = = 1 && MtsDcOnly = = 0 ) { | |
| if( ( ( CuPredMode[ chType ][ x0 ][ y0 ] = = MODE_INTER && | |
| sps_explicit_mts_inter_enabled_flag ) \| \| | |
| ( CuPredMode[ chType ][ x0 ][ y0 ] = = MODE_INTRA && | |
| sps_explicit_mts_intra_enabled_flag ) ) ) | |
| mts_idx | ae(v) |
| } | |
| } | |
| } | |

An example of residual coding syntax is as follows.

| | Descriptor |
|---|---|
| residual_coding( x0, y0, log2TbWidth, log2TbHeight, cIdx ) { | |
| if( sps_mts_enabled_flag && cu_sbt_flag && cIdx = = 0 && | |
| log2TbWidth = = 5 && log2TbHeight < 6 ) | |
| log2ZoTbWidth = 4 | |
| else | |
| log2ZoTbWidth = Min( log2TbWidth, 5 ) | |
| if( sps_mts_enabled_flag && cu_sbt_flag && cIdx = = 0 && | |
| log2TbWidth < 6 && log2TbHeight = = 5 ) | |
| log2ZoTbHeight = 4 | |
| else | |
| log2ZoTbHeight = Min( log2TbHeight, 5 ) | |
| if( log2TbWidth > 0 ) | |
| last_sig_coeff_x_prefix | ae(v) |
| if( log2TbHeight > 0 ) | |
| last_sig_coeff_y_prefix | ae(v) |
| if( last_sig_coeff_x_prefix > 3 ) | |
| last_sig_coeff_x_suffix | ae(v) |
| if( last_sig_coeff_y_prefix > 3 ) | |
| last_sig_coeff_y_suffix | ae(v) |
| log2TbWidth = log2ZoTbWidth | |
| log2TbHeight = log2ZoTbHeight | |
| remBinsPass1 = ( ( 1 << ( log2TbWidth + log2TbHeight ) ) * 7 ) >> 2 | |
| log2SbW = ( Min( log2TbWidth, log2TbHeight ) < 2 ? 1 : 2 ) | |
| log2SbH = log2SbW | |
| if( log2TbWidth + log2TbHeight > 3 ) | |
| if( log2TbWidth < 2 ) { | |
| log2SbW = log2TbWidth | |
| log2SbH = 4 − log2SbW | |
| } else if( log2TbHeight < 2 ) { | |
| log2SbH = log2TbHeight | |
| log2SbW = 4 − log2SbH | |
| } | |
| numSbCoeff = 1 << ( log2SbW + log2SbH ) | |
| lastScanPos = numSbCoeff | |
| lastSubBlock = ( 1 << ( log2TbWidth + log2TbHeight − ( log2SbW + log2SbH ) ) | |
| ) − 1 | |
| do { | |
| if( lastScanPos = = 0 ) { | |
| lastScanPos = numSbCoeff | |
| lastSubBlock− − | |
| } | |
| lastScanPos− − | |
| xS = DiagScanOrder[ log2TbWidth − log2SbW ][ log2TbHeight − log2SbH ] | |
| [ lastSubBlock ][ 0 ] | |
| yS = DiagScanOrder[ log2TbWidth − log2SbW ][ log2TbHeight − log2SbH ] | |
| [ lastSubBlock ][ 1 ] | |
| xC = ( xS << log2SbW ) + | |
| DiagScanOrder[ log2SbW ][ log2SbH ][ lastScanPos ][ 0 ] | |
| yC = ( yS << log2SbH ) + | |
| DiagScanOrder[ log2SbW ][ log2SbH ][ lastScanPos ][ 1 ] | |
| } while( ( xC != LastSignificantCoeffX ) \| \| ( yC != LastSignificantCoeffY ) ) | |
| if( lastSubBlock = = 0 && log2TbWidth >= 2 && log2TbHeight >= 2 && | |
| !transform_skip_flag[ x0 ][ y0 ][ cIdx ] && lastScanPos > 0 ) | |
| LfnstDcOnly = 0 | |
| if( ( lastSubBlock > 0 && log2TbWidth >= 2 && log2TbHeight >= 2 ) \| \| | |
| ( lastScanPos > 7 && ( log2TbWidth = = 2 \| \| log2TbWidth = = 3 ) && | |
| log2TbWidth = = log2TbHeight ) ) | |
| LfnstZeroOutSigCoeffFlag = 0 | |
| if( ( lastSubBlock > 0 \| \| lastScanPos > 0 ) && cIdx = = 0 ) | |
| MtsDcOnly = 0 | |
| QState = 0 | |
| for( i = lastSubBlock; i >= 0; i− − ) { | |
| startQStateSb = QState | |
| xS = DiagScanOrder[ log2TbWidth − log2SbW ][ log2TbHeight − log2SbH ] | |
| [ i ][ 0 ] | |
| yS = DiagScanOrder[ log2TbWidth − log2SbW ][ log2TbHeight − log2SbH ] | |
| [ i ][ 1 ] | |
| inferSbDcSigCoeffFlag = 0 | |
| if( i < lastSubBlock && i > 0 ) { | |
| sb_coded_flag[ xS ][ yS ] | ae(v) |
| inferSbDcSigCoeffFlag = 1 | |
| } | |
| if( sb_coded_flag[ xS ][ yS ] && ( xS > 3 \| \| yS > 3 ) && cIdx = = 0 ) | |
| MtsZeroOutSigCoeffFlag = 0 | |
| firstSigScanPosSb = numSbCoeff | |
| lastSigScanPosSb = −1 | |
| firstPosMode0 = ( i = = lastSubBlock ? lastScanPos : numSbCoeff − 1 ) | |
| firstPosMode1 = firstPosMode0 | |
| for( n = firstPosMode0; n >= 0 && remBinsPass1 >= 4; n− − ) { | |
| xC = ( xS << log2SbW ) + DiagScanOrder[ log2SbW ][ log2SbH ][ n ][ 0 ] | |
| yC = ( yS << log2SbH ) + DiagScanOrder[ log2SbW ][ log2SbH ][ n ][ 1 ] | |
| if( sb_coded_flag[ xS ][ yS ] && ( n > 0 \| \| !inferSbDcSigCoeffFlag ) && | |
| ( xC != LastSignificantCoeffX \| \| yC != Last SignificantCoeffY ) ) { | |
| sig_coeff_flag[ xC ][ yC ] | ae(v) |
| remBinsPass1− − | |
| if( sig_coeff_flag[ xC ][ yC ] ) | |
| inferSbDcSigCoeffFlag = 0 | |
| } | |
| if( sig_coeff_flag[ xC ][ yC ] ) { | |
| abs_level_gtx_flag[ n ][ 0 ] | ae(v) |
| remBinsPass1− − | |
| if( abs_level_gtx_flag[ n ][ 0 ] ) { | |
| par_level_flag[ n ] | ae(v) |
| remBinsPass1− − | |
| abs_level_gtx_flag[ n ][ 1 ] | ae(v) |
| remBinsPass1− − | |
| } | |
| if( lastSigScanPosSb = = −1) | |
| lastSigScanPosSb = n | |
| firstSigScanPosSb = n | |
| } | |
| AbsLevelPass1[ xC ][ yC ] = sig_coeff_flag[ xC ][ yC ] + par_level_flag[ n ] + | |
| abs_level_gtx_flag[ n ][ 0 ] + 2 * abs_level_gtx_flag[ n ][ 1 ] | |
| if( sh_dep_quant_used_flag ) | |
| QState = QStateTransTable[ QState ][ AbsLevelPass1[ xC ][ yC ] & 1 ] | |
| firstPosMode1 = n − 1 | |
| } | |
| for( n = firstPosMode0; n > firstPosMode1; n− − ) { | |
| xC = ( xS << log2SbW ) + DiagScanOrder[ log2SbW ][ log2SbH ][ n ][ 0 ] | |
| yC = ( yS << log2SbH ) + DiagScanOrder[ log2SbW ][ log2SbH ][ n ][ 1 ] | |
| if( abs_level_gtx_flag[ n ][ 1 ] ) | |
| abs_remainder[ n ] | ae(v) |
| AbsLevel[ xC ][ yC ] = AbsLevelPass1[ xC ][ yC ] +2 * abs_remainder[ n ] | |
| } | |
| for( n = firstPosMode1; n >= 0; n− − ) { | |
| xC = ( xS << log2SbW ) + DiagScanOrder[ log2SbW ][ log2SbH ][ n ][ 0 ] | |
| yC = ( yS << log2SbH ) + DiagScanOrder[ log2SbW ][ log2SbH ][ n ][ 1 ] | |
| if( sb_coded_flag[ xS ][ yS ] ) | |
| dec_abs_level[ n ] | ae(v) |
| if( AbsLevel[ xC ][ yC ] > 0 ) { | |
| if( lastSigScanPosSb = = −1 ) | |
| lastSigScanPosSb = n | |
| firstSigScanPosSb = n | |
| } | |
| if( sh_dep_quant_used_flag ) | |
| QState = QStateTransTable[ QState ][ AbsLevel[ xC ][ yC ] & 1 ] | |
| } | |
| signHiddenFlag = sh_sign_data_hiding_used_flag && | |
| ( lastSigScanPosSb − firstSigScanPosSb > 3 ? 1 : 0 ) | |
| for( n = numSbCoeff − 1; n >= 0; n− − ) { | |
| xC = ( xS << log2SbW ) + DiagScanOrder[ log2SbW ][ log2SbH ][ n ][ 0 ] | |
| yC = ( yS << log2SbH ) + DiagScanOrder[ log2SbW ][ log2SbH ][ n ][ 1 ] | |
| if( ( AbsLevel[ xC ][ yC ] > 0 ) && | |
| ( !signHiddenFlag \| \| ( n != firstSigScanPosSb ) ) ) | |
| coeff_sign_flag[ n ] | ae(v) |
| } | |
| if( sh_dep_quant_used_flag ) { | |
| QState = startQStateSb | |
| for( n = numSbCoeff − 1; n >= 0; n− − ) { | |
| xC = ( xS << log2SbW ) + DiagScanOrder[ log2SbW ][ log2SbH ][ n ][ 0 ] | |
| yC = ( yS << log2SbH ) + DiagScanOrder[ log2SbW ][ log2SbH ][ n ][ 1 ] | |
| if( AbsLevel[ xC ][ yC ] > 0 ) | |
| TransCoeffLevel[ x0 ][ y0 ][ cIdx ][ xC ][ yC ] = | |
| ( 2 * AbsLevel[ xC ][ yC ] − ( QState > 1 ? 1 : 0 ) ) * | |
| ( 1 − 2 * coeff_sign_flag[ n ] ) | |
| QState = QState TransTable[ QState ][ AbsLevel[ xC ][ yC ] & 1 ] | |
| } else { | |
| sumAbsLevel = 0 | |
| for( n = numSbCoeff − 1; n >= 0; n− − ) { | |
| xC = ( xS << log2SbW ) + DiagScanOrder[ log2SbW ][ log2SbH ][ n ][ 0 ] | |
| yC = ( yS << log2SbH ) + DiagScanOrder[ log2SbW ][ log2SbH ][ n ][ 1 ] | |
| if( AbsLevel[ xC ][ yC ] > 0 ) { | |
| TransCoeffLevel[ x0 ][ y0 ][ cIdx ][ xC ][ yC ] = | |
| AbsLevel[ xC ][ yC ] * ( 1 − 2 * coeff_sign_flag[ n ] ) | |
| if( signHiddenFlag ) { | |
| sumAbsLevel += AbsLevel[ xC ][ yC ] | |
| if( ( n = = firstSigScanPosSb ) && ( sumAbsLevel % 2 ) = = 1 ) ) | |
| TransCoeffLevel[ x0 ][ y0 ][ cIdx ][ xC ][ yC ] = | |
| −TransCoeffLevel[ x0 ][ y0 ][ cIdx ][ xC ][ yC ] | |
| } | |
| } | |
| } | |
| } | |
| } | |
| } | |

As noted above, a picture is partitioned into blocks prior to prediction and translation of residual. For example, a picture can be split into coding tree units (CTUs). A partition trees is then applied to each CTU to split the CTU into blocks. A partition tree can make use of several different types of splits such as quad tree (QT), horizontal binary tree (BT), vertical BT, horizontal triple tree (TT), vertical TT, etc. Unsymmetric binary tree (UBT) as discussed below is another example partition scheme that can be employed in a partition tree.

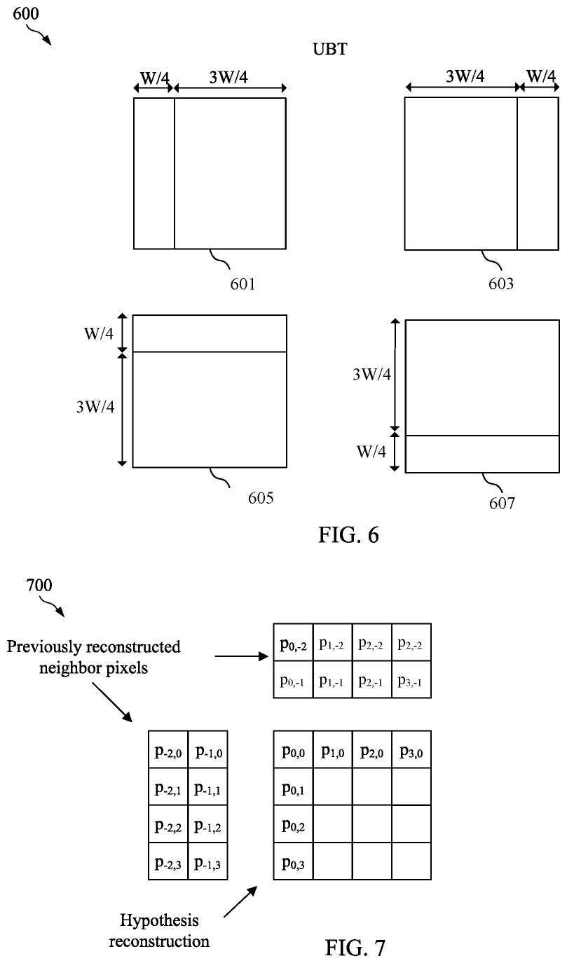

FIG. 6 is a schematic diagram 600 of example ¼ UBT partitioning structures, which includes vertical UBT (UBT-V) partitions and horizontal UBT (UBT-H) partitions. A block of dimensions W×H can be split into two sub-blocks dimensions W1×H1 and W2×H2, where one of the sub-blocks is a dyadic block and the other is a non-dyadic block. Such a split is named as Unsymmetric Binary Tree (UBT) split. In one example, W1=a×W, W2=(1−a)×W, and H1=H2=H. In such as case, the partition may be called a vertical UBT (UBT-V). In one example, a may be smaller than ½, such as ¼, ⅛, 1/16, 1/32, 1/64, etc. In such a case, the partition may be called a Type 0 UBT-V, an example of which is shown as split 601. In one example, a may be larger than ½, such as ¾, ⅞, 15/16, 31/32, 63/64, etc. In such a case, the partition is called a Type 1 UBT-V, an example of which is shown as split 603. In one example, H1=a×H, H2=(1−a)×H, W1=W2=W. In such as case, the partition may be called a horizontal UBT (UBT-H). In one example, a may be smaller than ½, such as ¼, ⅛, 1/16, 1/32, 1/64, etc. In such a case, the partition is called a Type 0 UBT-H, an example of which is shown as split 605. In one example, a may be larger than ½, such as ¾, ⅞, 15/16, 31/32, 63/64, etc. In such a case, the partition may be called a Type 1 UBT-H, an example of which is shown as split 607.

A mechanism for sign prediction for the signs of luma residual coefficients is now discussed. A number of signs per transform unit (TU) can be predicted as limited by a configuration parameter and the number of coefficients present. When predicting n signs in a TU, the encoder and decoder each perform n+1 partial inverse transformations and 2n border reconstructions corresponding to the 2n sign combination hypotheses. A border-cost measure is also employed for each. These costs are examined to determine sign prediction values. The encoder transmits a sign residual for each predicted sign indicating whether the prediction for that sign is correct or not using two additional context adaptive binary arithmetic coding (CABAC) contexts. The decoder reads these sign residuals and uses them during reconstruction to determine the correct signs to based on the decoder's predictions.

Sign prediction at the encoder is now discussed. Prior to encoding coefficients in a TU, the encoder determines which signs to predict, and predicts them. Hypothesis processing as described below is performed during rate distortion optimization (RDO) decision making. The prediction results are stored as correct or incorrect, per sign being predicted, in the CU for use in later encoding. During the final encoding stage, this stored data is used to reproduce the final bitstream containing sign residues.

Hypothesis generation is now discussed. The encoder initially dequantizes the TU and then chooses n coefficients for signs are to be predicted. The coefficients are scanned in raster-scan order. Dequantized values over a defined threshold are preferred over values lower than that threshold when collecting the n coefficients. With these n values, 2n simplified border reconstructions are performed as described below. This includes one reconstruction per unique combination of signs for the n coefficients.

For a particular reconstruction, only the leftmost and topmost pixels of a block are recreated from the inverse transformation added to the block prediction. Although the first (e.g., vertical) inverse transform is complete, the second (e.g., horizontal) inverse transform only has to create the leftmost and topmost pixel outputs. Hence, the second inverse transform is faster than the first. A top left (topLeft) flag is added to inverse transform functions to allow for this mechanism.

In addition, the number of inverse transform operations performed is reduced by using a system of templates. In this way, only n+1 inverse transform operations are performed when predicting n signs in a block. For example, a single inverse transform can be employed operating on the dequantized coefficients, where the values of all signs being predicted are set to positive. Once added to the prediction of the current block, this corresponds to the border reconstruction for the first hypothesis. For each of the n coefficients having their signs predicted, an inverse transform operation is performed on an otherwise empty block containing the corresponding dequantized (and positive) coefficient as the corresponding only non-null element. The leftmost and topmost border values are saved in what is termed a template for use during later reconstructions.

Border reconstruction for a later hypothesis begins by taking a saved reconstruction of a previous hypothesis. In an example, the saved reconstruction only needs a single predicted sign to be changed from positive to negative in order to construct the desired current hypothesis. This change of sign is then approximated by the doubling and subtraction from the hypothesis border of the template corresponding to the sign being predicted. The border reconstruction, after costing, is then saved, if known, to be reused for constructing later hypotheses.

| Template Name | How to Create |
|---|---|
| T001 | inv xform single + ve 1^{st} sign-hidden coeff |
| T010 | inv xform single + ve 2^{nd} sign-hidden coeff |
| T100 | inv xform single + ve 3^{rd} sign-hidden coeff |

| | | Store for |
|---|---|---|
| Hypothesis | How to Create | later reuse as |
| H000 | inv xform all coeffs add to pred | H000 |
| H001 | H000 − 2*T001 | |
| H010 | H000 − 2*T010 | H010 |
| H011 | H010 − 2*T001 | |
| H100 | H000 − 2*T100 | H100 |
| H101 | H100 − 2*T001 | |
| H110 | H100 − 2*T010 | H110 |
| H111 | H110 − 2*T001 | |

Table showing save/restore and template application for 3 sign 8 entry case

These approximations may only be during the process of sign prediction and not during final reconstruction.

FIG. 7 is a schematic diagram 700 of a mechanism for determining costs for a sign prediction hypothesis at a reconstructed border, which may also be referred to as hypothesis costing. There is a cost associated with each hypothesis that corresponds to the concept of image continuity at the block border. Sign prediction values are found by minimizing this cost. As shown in schematic diagram 700, a linear prediction is performed for each reconstructed pixel p_{0,y} at the left side of a reconstructed block. The linear prediction is performed for each of the left boundary blocks using the two pixels to the left of the corresponding block to obtain a prediction in the form of pred_{0,y}=(2_{p-1,y}−p_{-2,y}), where y is a corresponding vertical coordinate of the pixel p. The absolute difference between this prediction and the reconstructed pixel, denoted as p_{0,y}, is added to the cost of the hypothesis. Similar processing occurs for pixels in the top row of the reconstructed block. For example, the absolute differences of each prediction pred_{x,0}=(2_{px,-1}−p_{x,-2}) and reconstructed pixel, denoted as p_{x,0}, are summed, where x is a corresponding horizontal coordinate of the pixel p. As such, the sign prediction hypothesis cost can be determined as follows:

$$cos t = {\sum }_{x = 0}^{w - 1} \vert ( 2 {p}_{x , - 1} - {p}_{x , - 2} ) - {p}_{x , 0} \vert + {\sum }_{y = 0}^{h - 1} \vert ( 2 {p}_{- 1 , y} - {p}_{- 2 , y} ) - {p}_{0 , y} \vert$$

where cost is the sign prediction hypothesis cost, p indicates a pixel, x and y are horizontal and vertical coordinate components, h is a block height, and w is a block width. In the foregoing equation, (2p_{x,-1}−p_{x,-2}) and (2p_{-1,y}−p_{-2,y}) are the prediction and the p_{x,0} and p_{0,y} are the hypothesis reconstruction.

Prediction of multiple signs is now discussed. For each sign to be predicted, the encoder searches for the hypothesis having the lowest cost that agrees with the true values of the signs already transmitted. Initially, when no sign residues have been determined, this result corresponds to the lowest cost hypothesis. The predicted value of the current sign is taken from this hypothesis. When the prediction corresponds to the true value of the sign, a zero is used as the sign residue. Otherwise a one is used.

Final signaling of the sign prediction is now discussed. One of two CABAC contexts are used when signaling a particular sign prediction residue. The CABAC context to use is determined by whether or not the associated dequantized coefficient is lower or higher than a threshold. Prediction residues for higher-valued coefficients are sent through a CABAC context initialized to expect a higher probability of a correct prediction (e.g., a higher probability of expecting a zero residue). In an example, the context initializations are around 58% that are lower than threshold and around 74% that are equal to or higher than the threshold.

Other bitstream changes related to sign hypothesis signaling are now discussed. It should be noted that, as part of the software modifications applied to JEM version three (JEM3), the signaling of signs of all coefficients, including luma, chroma, predicted, and non-predicted blocks, has been moved to the end of the TU block. Accordingly, signs may not be signaled per coding group (CG). This supports proper decoding for luma. The decoder may need access to all coefficient values in the TU in order to determine the signs that are predicted and that, accordingly, have only their prediction residues in the bitstream. Although not strictly necessary for chroma, as signs may not be predicted for chroma, moving chroma signs to the end of the TU avoids having two different logic paths.

Parsing at the decoder is now discussed. The decoder, as part of the decoder's parsing process, parses coefficients, signs, and sign residues. The signs and sign residues are parsed at the end of the TU. At that point, the decoder can determine the absolute values of all coefficients. Thus, the decoder can determine what signs are predicted and, for each predicted sign, the decoder can determine the context to use to parse the sign prediction residue based on the dequantized coefficient values. The knowledge of a correct or incorrect prediction is stored as part of the CU data of the block being parsed. The real sign of the coefficient may not be known by the decoder at this point when the CU data is parsed (e.g., decoder is unaware of the real sign until the TU is parsed).

Reconstruction at the decoder is now discussed. During reconstruction, the decoder performs operations similar to the encoder (as described above for the encoder during the RDO). For n signs being predicted in the TU, the decoder performs n+1 inverse transform operations, and 2n border reconstructions to determine hypothesis costs. The real sign to apply to a coefficient with a predicted sign is determined by an exclusive-or operation on the predicted value of the sign and the correct or incorrect data stored in the CU during bitstream parsing.

Interaction with sign data hiding is now discussed. In each TU where the sign of a coefficient is hidden using the sign data hiding mechanism, sign prediction treats such coefficient as not available for further prediction technique. The sign prediction process uses only other non-hidden sign coefficients for further prediction.

The following are example technical problems solved by disclosed technical solutions. Some designs for the picture parameter set (PPS), picture header (PH), and slice header (SH) syntax have the following problems. For example, LFNST (described above as RST) is not applied on chroma components for a single-tree in VVC. However, LFNST direct current (DC) only (LfnstDcOnly) flag and the LFNST zero out sign coefficient flag (LfnstZeroOutSigCoeffFlag) may be set by a determination based on the chroma components. Accordingly, such flags may not be set properly in some designs. Furthermore, the signaling of a LFNST index in the bitstream may depend on the transform skip flag for all luma (Y), blue difference chroma (Cb), and red difference chroma (Cr) components in single-tree. This may occur even though LFNST would never be used for the chroma components in single-tree in such designs (e.g., and hence should not depend on Cb and Cr. In addition, some designs do not describe how sign prediction can be applied to non-dyadic blocks. A non-dyadic block is a block with at least one dimension that cannot be expressed as a power of two. Furthermore, interactions between sign prediction and other VVC coding tools such as secondary transform (e.g., LFNST), dual tree partition, transform skip residual coding (e.g., TSRC), joint Cb-Cr coding, and etc. are unclear in some designs.

The preceding problems are now summarized. For example, a sign prediction mechanism, as discussed in schematic diagram 700, may be employed in some systems. For example, the encoder encodes prediction and encodes residual remaining from prediction. The encoder encodes the residual by transforming the residual into residual coefficients and applying quantization. The encoder then signals signs for the residual coefficients via sign prediction. In sign prediction, the encoder dequantized a block, selects residual coefficients for sign prediction, and applies an inverse transform to the selected residual coefficients. For example, the encoder can select a hypothesis function to project the sign for each of the selected residual coefficients. The samples are then reconstructed based on the hypothesis function and the inverse transform. The encoder employs a cost determination mechanism to select the hypothesis function that results in the least difference between the reconstructed samples and the encoded samples. The encoder can then encode the selected hypothesis function and any difference between the reconstructed samples and the encoded samples. The decoder can then use the signaled hypothesis function, the inverse transform, and the difference to reconstruct accurate samples. This approach allows coefficient signs to be omitted from the bitstream and replaced by a hypothesis function and a difference between the reconstructed samples and the encoded samples (e.g., a residual of the residual). The sign prediction mechanism may be used in conjunction with transforms selected according to LFNST, also known as RST, as discussed with respect to schematic diagram 200, 300, 400, and 500. The LFNST and the sign prediction may not operate efficiently and/or correctly for certain blocks.

Disclosed herein are mechanisms to address one or more of the problems listed above. In an example, the sign prediction mechanism is designed to operate on dyadic blocks, but may not operate correctly on non-dyadic blocks. In an example, sign prediction may be disallowed for non-dyadic blocks. In another example, sign prediction can be limited to a dyadic sized group of residual coefficients within a non-dyadic block. Further, sign prediction can be disallowed for blocks with a width (W) and/or a height (H) that meets certain predefined conditions. In cases where sign prediction is disallowed, corresponding syntax can be omitted from the bitstream and the decoder can determine the disallowance by inference. In another example, application of sign prediction for a chroma component can be determined based on application of sign prediction to a luma component. In some examples, samples reconstructed according to a hypothesis function can be determined and stored in tables for use by a RDO process. In an example, the reconstructed samples can be grouped into one or more sets, and the sets can be reconstructed based on corresponding residual coefficient(s) according to one or more predetermined patterns. The reconstructed sample sets can then be used to derive a final set of reconstructed samples for use in determining hypothesis costs for hypothesis functions. In an example, a first table may store the reconstructed samples in entries, and a second table may be used to derive indices into the first table. In an example, different rules can be applied to signs for different coefficients within a block. In an example, signs for a second coefficient can be dependent on a first coefficient. In an example, a maximum number of signs that can be predicted for a block may depend on block position relative to a boundary. The maximum number of signs that can be predicted for a block may be signaled in a bitstream or determined dynamically, for example based on block size, block type, block location, and/or coded information for a neighboring block. In an example, a sign prediction can be determined based on coding information for a block such as a quantization parameter (QP), a prediction mode, a coding tool, motion information, a color component, a color format, a temporal layer, a slice type, a neighboring block information, a coding tree depth, the residual coefficients of the block, a transform type, a residual coding mode, a partition tree type, or combinations thereof.

As noted, LFNST may also not operate correctly in some scenarios because LFNST uses flags that depend on chroma components, but LFNST may not be applied to chroma components in some cases. In an example, this issue is address by determining whether to signal a LFNST index based on a first variable. The first variable is modified by at least one of color component of the block, coding structure of the block, or block type of the block. For example, the variable may be a LfnstDcOnly flag and/or a LfnstZeroOutSigCoeffFlag. Hence, the LFNST index may be signaled based on whether there is only one DC non-zero coefficient in the residual block and/or based on a range of non-zero coefficients in the residual block, respectively. In an example, the first variable may be modified by a transform skip flag. In an example, the first variable may not be modified when parsing a residual block of a first color component when single-tree coding structure is applied. In an example, the first variable may be modified when parsing a residual block of a first color component when a dual-tree coding structure is applied or when parsing a residual block of a first color component when a dual-tree coding structure is applied. In an example, the determination whether to signal the LFNST index is based on a modified value in the first variable. In an example, one or more of these changes can be applied to allow LFNST to operate with respect to a non-dyadic block.

The detailed embodiments below should be considered as examples to explain general concepts. These embodiments should not be interpreted in a narrow way. Furthermore, these embodiments can be combined in any manner. In the following discussion, a block is a dyadic block if both width and height is a dyadic number, which is in a form of a 2N with N being a positive integer. In the following discussion, a block is a non-dyadic block if at least one of width and height is a non-dyadic number, which cannot be represented in a form of a 2N with N being a positive integer. In the following discussion, split and partitioning have the same meaning. In the following discussion, a first sub-block width (W1) and a second sub-block width (W2) are related to a parent block width (W). In one example, W1 is calculated as 1«└log₂W┘, W2 is calculated as 1«[log₂ W]. Further, a first sub-block height (H1) and a second sub-block height (H2) are related to a parent block height (H). In one example, H1 is calculated as 1«[log₂H] and H2 is calculated as 1<<[log₂H].

### Example 1

In one example, the determination of whether to signal a syntax element related to LFNST (e.g. LFNTS index (lfnst_idx) in VVC) may depend on a first variable. The first variable may be modified depending on the color component and/or the coding structure or block types (e.g., dyadic or non-dyadic blocks). In one example, the first variable may be related to whether there is only one DC non-zero coefficient in the residual block. For example, the first variable may be the LfnstDcOnly flag defined in VVC. In one example, the first variable may be related to a range of non-zero coefficients in the residual block. For example, the first variable may be the LfnstZeroOutSigCoeffFlag defined in VVC. In one example, the first variable may be related to the transform skip flag of a video unit, which may be a transform block (TB). In one example, the first variable is not modified when parsing a residue block of a first color component when a single-tree coding structure is applied. For example, a single tree coding structure is applied when luma and chroma share the same coding tree structure. In one example, the first color component may be a chroma component such as Cb or Cr.

In one example, the first variable may be modified when parsing a residue block of a first color component when a dual-tree coding structure is applied. For example, a dual-tree coding structure is applied when luma and chroma have individual coding tree structures. In one example, the first color component may be a chroma component such as Cb or Cr. In one example, the first variable may be modified when parsing a residue block of a first color component when a local dual-tree coding structure is applied. For example, a dual-tree coding structure is applied when luma and chroma have individual coding tree structures. In one example, the first color component may be a chroma component such as Cb or Cr. In one example, the first variable may be modified when parsing a residue block of a second color component. In one example, the second color component may be a luma component. In any of these examples, the modified value may be used to determine whether to signal the syntax element related to LFNST when the first variable is modified. In one example, the examples above may be applied on a non-dyadic block.

### Example 2

In one example, whether to and/or how to apply sign prediction on a block may depend on dimensions of the block, where the dimensions of the block are width (W) and height (H). In an example, whether to and/or how to apply sign prediction may depend on whether the block is dyadic or non-dyadic. In one example, sign prediction is not applied for a non-dyadic block. In one example, when sign prediction is applied for a non-dyadic block, only the first M×N residual coefficients are considered. For example, M may be a dyadic number less than W. For example, N may be a dyadic number less than H. In one example, sign prediction is not applied when W % M !=0 and/or when H % M !=0, wherein M is an integer such as 4 or 8, % is the modulo operator, and !=indicates not equal to. In one example, sign prediction is not applied if W&M !=0 and/or H&M !=0, wherein & is an and operation, and M is an integer such as 3 or 7.

In one example, the syntax element(s) related to sign prediction for the block may be conditionally signaled depending on dimensions of the block. For example, when a coding device determines that sign prediction is not applied according to dimensions of the block, the syntax element(s) related to sign prediction may not be signaled. In an example, the block may be a coding unit (CU), a transform unit (TU), a coding block (CB), and/or a TB. In one example, the determination of whether to and/or how to apply to a second color component may depend on the block dimension of a first color component. In one example, the first color component is luma or green (G), and the second color component is blue difference chroma (Cb), red difference chroma (Cr), blue (B), and/or red (R).

### Example 3

In one example, a first set of hypothesis reconstrued N samples at top and/or left boundaries of a block may be stored when the block has dimensions W×H. In an example, N=W+H−1. In one example, W and/or H may be non-dyadic number(s), where a non-dyadic number is a number that cannot be expressed as a power of two. In one example, the first set of hypothesis reconstrued N samples may be corresponding to a pattern of coefficients. For example, the first set may be set to be the reconstrued N samples when the all the coefficients in the block is set to be zero except one coefficient at position (x0, y0) which is set to be non-zero. This may occur when the residual includes a single coefficient at a coordinate denoted (x0, y0), where x0 and y0 are horizontal and vertical components of a top left position of the block. For example, (x0, y0) is a position whose sign value may be predicted.

In one example, K sets of hypothesis reconstrued N samples may be stored. In an example, N=W+H−1. For example, each set of the hypothesis reconstrued N samples may correspond to one specific coefficient whose sign value may be predicted. In an example, N=W+H−1. In one example, a combination of all or some of the K sets of hypothesis reconstrued N samples may be used to derive a final set of estimated reconstrued N samples. The final set of estimated reconstrued N samples may be used to calculate the cost for a possible pattern of predicted signs. In an example, N=W+H−1. In one example, a first table (T) may be used to store all the sets of hypothesis reconstrued N samples, and a second table (S) may be used to derive a index referring to an entry in the first table. In an example, N=W+H−1. In one example, the second table is indexed by an integer. In one example, S[(W>>p)−q] and S[(H>>p)−q] may be used to find an entry in the first table, where SH indicates a second table entry, W is block width, and H is block height. For example, p and/or q may be 0, 1, 2, 3, and/or 4. For example, p=1, q=2. The stored samples may be used to derive the sign information.

### Example 4

In one example, different rules may be applied when predicting two signs within a block. In one example, a first rule may be applied for a coefficient located at (x0, y0) relative to the top-left corner of the block. In one example, a second rule may be applied for a coefficient located at (x1, y1) relative to the top-left corner of the block, where x0 is not equal to x1 and/or y0 is not equal to y1.

### Example 5

In one example, the prediction of a sign for a second coefficient may be dependent on the predicted sign of the first coefficient within a block.

### Example 6

In one example, a number of signs to be predicted and/or a maximum number of signs to be predicted may be different from one block to another block. In one example, a number/maximum number of signs to be predicted may be dependent on the location of the block, for example based on whether the block is located at a picture boundary, a slice boundary, and/or a picture boundary. In one example, a number/maximum number of signs to be predicted may be dependent on coding information, such as block dimension and/or block types.

### Example 7

In one example, a number/maximum number of signs to be predicted may be determined on-the-fly. In one example, the number/maximum number of signs to be predicted may be dependent on the location of the block, for example based on whether the block is located at a picture boundary, a slice boundary, and/or a picture boundary. In one example, a number/maximum number of signs to be predicted may be dependent on coding information, such as block dimension and/or block types.

### Example 8

In an example, whether and/or how to apply sign prediction on a block may depend on coding information. This may include how to determine calculation cost and/or how to determine signs according to a given cost. Coding information may comprise: quantization parameter (QP); prediction mode, such as inter mode or intra mode; coding tool, such as whether subblock-based methods are applied or not; motion information; intra-prediction mode; color component; color format; temporal layer; slice type and/or picture type; information of neighboring block(s); and/or coding tree depth.

In an example, coding information may comprise residual coefficients and/or transform coefficients of the block and/or corresponding adjacent and/or non-adjacent neighboring blocks. In one example, the sign prediction may be disabled when a number of non-zero coefficients is no greater than or no smaller than a threshold. In one example, the determination may depend on the last non-zero coefficient information, such as corresponding coefficient position and/or coefficient values.

In an example, coding information may comprise transform type, such as primary transform, secondary transform, transform skip or not, discrete cosine transform (DCT) type 2 (DCT-II) or not, etc. In one example, sign prediction may be not applied to the secondary transformed coefficients. In one example, sign prediction may be not applied to LFNST coded blocks. In one example, sign prediction may be applied to coefficient blocks regardless whether the block is primary transform coded or secondary transform coded. In one example, sign prediction may be only applied to a specific transform type for the video block. Such transform types may include DCT-II, discrete sine transform (DST) type seven (DST-VII), DCT type three (DCT-III), etc. In an example, sign prediction may be not applied to certain transform types.

In an example, coding information may comprise coefficient coding mode, such as regular residual coding (RRC), transform skip residual coding (TSRC), and/or using joint coding of chroma residual (JCCR) or not. In one example, sign prediction may be not applied to the transform skipped blocks. In one example, sign prediction may be not applied to a video unit and/or block coded with transform skip mode. In one example, sign prediction may be not applied to a video unit and/or block coded with transform skip based residual coding (TSRC). In one example, sign prediction may be not applied to a JCCR block.

In an example, coding information may comprise partition and/or coding tree type, such as single tree or dual tree. In one example, sign prediction may be not applied when a dual coding tree is used. In one example, sign prediction may be not applied in a local dual tree is used. In an example, sign prediction may be applied regardless of the tree type.

Below are some example implementations for some of the example aspects summarized above, which can be applied to the VVC specification. The changed texts are based on the VVC text. Most relevant parts that have been added or modified are shown in bold underlined font.

An example transform unit syntax is as follows.

| | Descriptor |
|---|---|
| transform_unit( x0, y0, tbWidth, tbHeight, treeType, subTuIndex, chType ) { | |
| if( IntraSubPartitionsSplitType != ISP_NO_SPLIT && | |
| treeType = = SINGLE_TREE && subTuIndex = = | |
| NumIntraSubPartitions − 1 ) { | |
| xC = CbPosX[ chType ][ x0 ][ y0 ] | |
| yC = CbPosY[ chType ][ x0 ][ y0 ] | |
| wC = CbWidth[ chType ][ x0 ][ y0 ] / Sub WidthC | |
| hC = CbHeight[ chType ][ x0 ][ y0 ] / SubHeightC | |
| } else { | |
| xC = x0 | |
| yC = y0 | |
| wC = tbWidth / SubWidthC | |
| hC = tbHeight / SubHeightC | |
| } | |
| chromaAvailable = treeType != DUAL_TREE_LUMA && | |
| sps_chroma_format_idc != 0 && | |
| ( IntraSubPartitionsSplitType = = ISP_NO_SPLIT | |
| ( IntraSubPartitionsSplitType != ISP_NO_SPLIT && | |
| subTuIndex = = NumIntraSubPartitions − 1 ) ) | |
| if( ( treeType = = SINGLE_TREE \| \| treeType = = DUAL_TREE_CHROMA ) | |
| && | |
| sps_chroma_format_idc != 0 && | |
| ( ( IntraSubPartitionsSplitType = = ISP_NO_SPLIT && !( cu_sbt_flag && | |
| ( ( subTuIndex = = 0 && cu_sbt_pos_flag ) \| \| | |
| ( subTuIndex = = 1 && !cu_sbt_pos_flag ) ) ) ) \| \| | |
| ( IntraSubPartitionsSplitType != ISP_NO_SPLIT && | |
| ( subTuIndex = = NumIntraSubPartitions − 1 ) ) ) ) { | |
| tu_cb_coded_flag[ xC ][ yC ] | ae(v) |
| tu_cr_coded_flag[ xC ][ yC ] | ae(v) |
| } | |
| if( treeType = = SINGLE_TREE \| \| treeType = = DUAL_TREE_LUMA ) { | |
| if( ( IntraSubPartitionsSplitType = = ISP_NO_SPLIT && !( cu_sbt_flag && | |
| ( ( subTuIndex = = 0 && cu_sbt_pos_flag ) \| \| | |
| ( subTuIndex = = 1 && !cu_sbt_pos_flag ) ) ) && | |
| ( ( CuPredMode[ chType ][ x0 ][ y0 ] = = MODE_INTRA && | |
| !cu_act_enabled_flag[ x0 ][ y0 ] ) \| \| | |
| ( chromaAvailable && ( tu_cb_coded_flag[ xC ][ yC ] \| \| | |
| tu_cr_coded_flag[ xC ][ yC ] ) ) \| \| | |
| CbWidth[ chType ][ x0 ][ y0 ] > MaxTbSizeY \| \| | |
| CbHeight[ chType ][ x0 ][ y0 ] > MaxTbSizeY ) ) \| \| | |
| ( IntraSubPartitionsSplitType != ISP_NO_SPLIT && | |
| ( subTuIndex < NumIntraSubPartitions − 1 \| \| !InferTuCbfLuma ) ) ) | |
| tu_y_coded_flag[ x0 ][ y0 ] | ae(v) |
| if(IntraSubPartitionsSplitType != ISP_NO_SPLIT ) | |
| InferTuCbfLuma = InferTuCbfLuma && !tu_y_coded_flag[ x0 ][ y0 ] | |
| } | |
| if( ( CbWidth[ chType ][ x0 ][ y0 ] > 64 \| \| CbHeight[ chType ][ x0 ][ y0 ] > 64 \| \| | |
| tu_y_coded_flag[ x0 ][ y0 ] \| \| ( chromaAvailable && ( | |
| tu_cb_coded_flag[ xC ][ yC ] \| \| | |
| tu_cr_coded_flag[ xC ][ yC ] ) ) && treeType != DUAL_TREE_CHROMA | |
| && | |
| pps_cu_qp_delta_enabled_flag && !IsCuQpDeltaCoded ) { | |
| cu_qp_delta_abs | ae(v) |
| if( cu_qp_delta_abs ) | |
| cu_qp_delta_sign_flag | ae(v) |
| } | |
| if( ( CbWidth[ chType ][ x0 ][ y0 ] > 64 \| \| CbHeight[ chType ][ x0 ][ y0 ] > 64 \| \| | |
| ( chromaAvailable && ( tu_cb_coded_flag[ xC ][ yC ] \| \| | |
| tu_cr_coded_flag[ xC ][ yC ] ) ) ) && | |
| treeType != DUAL_TREE_LUMA && | |
| sh_cu_chroma_qp_offset_enabled_flag && | |
| !IsCuChromaQpOffsetCoded ) { | |
| cu_chroma_qp_offset_flag | ae(v) |
| if( cu_chroma_qp_offset_flag && pps_chroma_qp_offset_list_len_minus1 > 0 ) | |
| cu_chroma_qp_offset_idx | ae(v) |
| } | |
| if( sps_joint_cbcr_enabled_flag && ( ( CuPredMode[ chType ][ x0 ][ y0 ] = = | |
| MODE_INTRA | |
| && ( tu_cb_coded_flag[ xC ][ yC ] \| \| tu_cr_coded_flag[ xC ][ yC ] ) ) \| \| | |
| ( tu_cb_coded_flag[ xC ][ yC ] && tu_cr_coded_flag[ xC ][ yC ] ) ) && | |
| chromaAvailable ) | |
| tu_joint_cbcr_residual_flag[ xC ][ yC ] | ae(v) |
| if( tu_y_coded_flag[ x0 ][ y0 ] && treeType != DUAL_TREE_CHROMA ) { | |
| if( sps_transform_skip_enabled_flag && !BdpcmFlag[ x0 ][ y0 ][ 0 ] && | |
| tbWidth <= MaxTsSize && tbHeight <= MaxTsSize && | |
| ( IntraSubPartitionsSplitType = = ISP_NO_SPLIT ) && !cu_sbt_flag ) | |
| transform_skip_flag[ x0 ][ y0 ][ 0 ] | ae(v) |
| if( !transform_skip_flag[ x0 ][ y0 ][ 0 ] \| \| sh_ts_residual_coding_disabled_flag ) | |
| residual_coding( x0, y0, Log2( tbWidth ), Log2( tbHeight ), 0, treeType ) | |
| else | |
| residual_ts_coding( x0, y0, Log2( tbWidth ), Log2( tbHeight ), 0 ) | |
| } | |
| if( tu_cb_coded_flag[ xC ][ yC ] && treeType != DUAL_TREE_LUMA ) { | |
| if( sps_transform_skip_enabled_flag && !BdpcmFlag[ x0 ][ y0 ][ 1 ] && | |
| wC <= MaxTsSize && hC <= MaxTsSize && !cu_sbt_flag ) | |
| transform_skip_flag[ xC ][ yC ][ 1 ] | ae(v) |
| if( !transform_skip_flag[ xC ][ yC ][ 1 ] \| \| sh_ts_residual_coding_disabled_flag ) | |
| residual_coding( xC, yC, Log2( wC ), Log2( hC ), 1, treeType ) | |
| else | |
| residual_ts_coding( xC, yC, Log2( wC ), Log2( hC ), 1 ) | |
| } | |
| if( tu_cr_coded_flag[ xC ][ yC ] && treeType != DUAL_TREE_LUMA && | |
| !( tu_cb_coded_flag[ xC ][ yC ] && tu_joint_cbcr_residual_flag[ xC ][ yC ] ) ) | |
| { | |
| if( sps_transform_skip_enabled_flag && !BdpcmFlag[ x0 ][ y0 ][ 2 ] && | |
| wC <= MaxTsSize && hC <= MaxTsSize && !cu_sbt_flag ) | |
| transform_skip_flag[ xC ][ yC ][ 2 ] | ae(v) |
| if( !transform_skip_flag[ xC ][ yC ][ 2 ] \| \| sh_ts_residual_coding_disabled_flag ) | |
| residual_coding( xC, yC, Log2( wC ), Log2( hC ), 2, treeType ) | |
| else | |
| residual_ts_coding( xC, yC, Log2( wC ), Log2( hC ), 2 ) | |
| } | |
| } | |

An example residual coding syntax is as follows.

| | Descriptor |
|---|---|
| residual_coding( x0, y0, log2TbWidth, log2TbHeight, cIdx, treeType ) { | |
| if( sps_mts_enabled_flag && cu_sbt_flag && cIdx = = 0 && | |
| log2TbWidth = = 5 && log2TbHeight < 6 ) | |
| log2ZoTbWidth = 4 | |
| else | |
| log2ZoTbWidth = Min( log2TbWidth, 5 ) | |
| if( sps_mts_enabled_flag && cu_sbt_flag && cIdx = = 0 && | |
| log2TbWidth < 6 && log2TbHeight = = 5 ) | |
| log2ZoTbHeight = 4 | |
| else | |
| log2ZoTbHeight = Min( log2TbHeight, 5 ) | |
| if( log2TbWidth > 0 ) | |
| last_sig_coeff_x_prefix | ae(v) |
| if( log2TbHeight > 0 ) | |
| last_sig_coeff_y_prefix | ae(v) |
| if( last_sig_coeff_x_prefix > 3 ) | |
| last_sig_coeff_x_suffix | ae(v) |
| if( last_sig_coeff_y_prefix > 3 ) | |
| last_sig_coeff_y_suffix | ae(v) |
| log2TbWidth = log2ZoTbWidth | |
| log2TbHeight = log2ZoTbHeight | |
| remBinsPass1 = ( ( 1 << ( log2TbWidth + log2TbHeight ) ) * 7 ) >> 2 | |
| log2SbW = ( Min( log2TbWidth, log2TbHeight ) < 2 ? 1 : 2 ) | |
| log2SbH = log2SbW | |
| if( log2TbWidth + log2TbHeight > 3 ) | |
| if( log2TbWidth < 2 ) { | |
| log2SbW = log2TbWidth | |
| log2SbH = 4 − log2SbW | |
| } else if( log2TbHeight < 2 ) { | |
| log2SbH = log2TbHeight | |
| log2SbW = 4 − log2SbH | |
| } | |
| numSbCoeff = 1 << ( log2SbW + log2SbH ) | |
| lastScanPos = numSbCoeff | |
| lastSubBlock = ( 1 << ( log2TbWidth + log2TbHeight − ( log2SbW + log2SbH ) ) | |
| ) − 1 | |
| do { | |
| if( lastScanPos = = 0 ) { | |
| lastScanPos = numSbCoeff | |
| lastSubBlock− − | |
| } | |
| lastScanPos− − | |
| xS = DiagScanOrder[ log2TbWidth − log2SbW ][ log2TbHeight − log2SbH ] | |
| [ lastSubBlock ][ 0 ] | |
| yS = DiagScanOrder[ log2TbWidth − log2SbW ][ log2TbHeight − log2SbH ] | |
| [ lastSubBlock ][ 1 ] | |
| xC = ( xS << log2SbW ) + | |
| DiagScanOrder[ log2SbW ][ log2SbH ][ lastScanPos ][ 0 ] | |
| yC = ( yS << log2SbH ) + | |
| DiagScanOrder[ log2SbW ][ log2SbH ][ lastScanPos ][ 1 ] | |
| } while( ( xC != LastSignificantCoeffX ) \| \| ( yC != LastSignificantCoeffY ) ) | |
| if( lastSubBlock = = 0 && log2TbWidth >= 2 && log2TbHeight >= 2 && | |
| !transform_skip_flag[ x0 ][ y0 ][ cIdx ] && lastScanPos > 0 && !(cIdx > 0 | |
| && treeType = = SINGLE_TREE)) | |
| LfnstDcOnly = 0 | |
| if(( ( lastSubBlock > 0 && log2TbWidth >= 2 && log2TbHeight >= 2 ) \| \| | |
| ( lastScanPos > 7 && ( log2TbWidth = = 2 \| \| log2TbWidth = = 3 ) && | |
| log2TbWidth = = log2TbHeight ) ) && !(cIdx > 0 && treeType = = | |
| SINGLE_TREE)) | |
| LfnstZeroOutSigCoeffFlag = 0 | |
| if( ( lastSubBlock > 0 \| \| lastScanPos > 0 ) && cIdx = = 0 ) | |
| MtsDcOnly = 0 | |
| QState = 0 | |
| for( i = lastSubBlock; i >= 0; i− − ) { | |
| startQStateSb = QState | |
| xS = DiagScanOrder[ log2TbWidth − log2SbW ][ log2TbHeight − log2SbH ] | |
| [ i ][ 0 ] | |
| yS = DiagScanOrder[ log2TbWidth − log2SbW ][ log2TbHeight − log2SbH ] | |
| [ i ][ 1 ] | |
| inferSbDcSigCoeffFlag = 0 | |
| if( i < lastSubBlock && i > 0 ) { | |
| sb_coded_flag[ xS ][ yS ] | ae(v) |
| inferSbDcSigCoeffFlag = 1 | |
| } | |
| if( sb_coded_flag[ xS ][ yS ] && ( xS > 3 \| \| yS > 3 ) && cIdx = = 0 ) | |
| MtsZeroOutSigCoeffFlag = 0 | |
| firstSigScanPosSb = numSbCoeff | |
| lastSigScanPosSb = −1 | |
| firstPosMode0 = ( i = = lastSubBlock ? lastScanPos : numSbCoeff − 1 ) | |
| firstPosMode1 = firstPosMode0 | |
| for( n = firstPosMode0; n >= 0 && remBinsPass1 >= 4; n− − ) { | |
| xC = ( xS << log2SbW ) + DiagScanOrder[ log2SbW ][ log2SbH ][ n ][ 0 ] | |
| yC = ( yS << log2SbH ) + DiagScanOrder[ log2SbW ][ log2SbH ][ n ][ 1 ] | |
| if( sb_coded_flag[ xS ][ yS ] && ( n > 0 \| \| !inferSbDcSigCoeffFlag ) && | |
| ( xC != LastSignificantCoeffX \| \| yC != Last SignificantCoeffY ) ) { | |
| sig_coeff_flag[ xC ][ yC ] | ae(v) |
| remBinsPass1− − | |
| if( sig_coeff_flag[ xC ][ yC ] ) | |
| inferSbDcSigCoeffFlag = 0 | |
| } | |
| if( sig_coeff_flag[ xC ][ yC ] ) { | |
| abs_level_gtx_flag[ n ][ 0 ] | ae(v) |
| remBinsPass1− − | |
| if( abs_level_gtx_flag[ n ][ 0 ] ) { | |
| par_level_flag[ n ] | ae(v) |
| remBinsPass1− − | |
| abs_level_gtx_flag[ n ][ 1 ] | ae(v) |
| remBinsPass1− − | |
| } | |
| if( lastSigScanPosSb = = −1 ) | |
| lastSigScanPosSb = n | |
| firstSigScanPosSb = n | |
| } | |
| AbsLevelPass1[ xC ][ yC ] = sig_coeff_flag[ xC ][ yC ] + par_level_flag[ n ] + | |
| abs_level_gtx_flag[ n ][ 0 ] + 2 * abs_level_gtx_flag[ n ][ 1 ] | |
| if( sh_dep_quant_used_flag ) | |
| QState = QStateTransTable[ QState ][ AbsLevelPass1[ xC ][ yC ] & 1 ] | |
| firstPosMode1 = n − 1 | |
| } | |
| for( n = firstPosMode0; n > firstPosMode1; n− − ) { | |
| xC = ( xS << log2SbW ) + DiagScanOrder[ log2SbW ][ log2SbH ][ n ][ 0 ] | |
| yC = ( yS << log2SbH ) + DiagScanOrder[ log2SbW ][ log2SbH ][ n ][ 1 ] | |
| if( abs_level_gtx_flag[ n ][ 1 ] ) | |
| abs_remainder[ n ] | ae(v) |
| AbsLevel[ xC ][ yC ] = AbsLevelPass1[ xC ][ yC ] +2 * abs_remainder[ n ] | |
| } | |
| for( n = firstPosMode1; n >= 0; n− − ) { | |
| xC = ( xS << log2SbW ) + DiagScanOrder[ log2SbW ][ log2SbH ][ n ][ 0 ] | |
| yC = ( yS << log2SbH ) + DiagScanOrder[ log2SbW ][ log2SbH ][ n ][ 1 ] | |
| if( sb_coded_flag[ xS ][ yS ] ) | |
| dec_abs_level[ n ] | ae(v) |
| if( AbsLevel[ xC ][ yC ] > 0 ) { | |
| if( lastSigScanPosSb = = −1 ) | |
| lastSigScanPosSb = n | |
| firstSigScanPosSb = n | |
| } | |
| if( sh_dep_quant_used_flag ) | |
| QState = QStateTransTable[ QState ][ AbsLevel[ xC ][ yC ] & 1 ] | |
| } | |
| signHiddenFlag = sh_sign_data_hiding_used_flag && | |
| ( lastSigScanPosSb − firstSigScanPosSb > 3 ? 1 : 0 ) | |
| for( n = numSbCoeff − 1; n >= 0; n− − ) { | |
| xC = ( xS << log2SbW ) + DiagScanOrder[ log2SbW ][ log2SbH ][ n ][ 0 ] | |
| yC = ( yS << log2SbH ) + DiagScanOrder[ log2SbW ][ log2SbH ][ n ][ 1 ] | |
| if( ( AbsLevel[ xC ][ yC ] > 0 ) && | |
| ( !signHiddenFlag \| \| ( n != firstSigScanPosSb ) ) ) | |
| coeff_sign_flag[ n ] | ae(v) |
| } | |
| if( sh_dep_quant_used_flag ) { | |
| QState = startQStateSb | |
| for( n = numSbCoeff − 1; n >= 0; n− − ) { | |
| xC = ( xS << log2SbW ) + DiagScanOrder[ log2SbW ][ log2SbH ][ n ][ 0 ] | |
| yC = ( yS << log2SbH ) + DiagScanOrder[ log2SbW ][ log2SbH ][ n ][ 1 ] | |
| if( AbsLevel[ xC ][ yC ] > 0 ) | |
| TransCoeffLevel[ x0 ][ y0 ][ cIdx ][ xC ][ yC ] = | |
| ( 2 * AbsLevel[ xC ][ yC ] − ( QState > 1 ? 1 : 0 ) ) * | |
| (1 − 2 * coeff_sign_flag[ n ] ) | |
| QState = QStateTransTable[ QState ][ AbsLevel[ xC ][ yC ] & 1 ] | |
| } else { | |
| sumAbsLevel = 0 | |
| for( n = numSbCoeff − 1; n >= 0; n− − ) { | |
| xC = ( xS << log2SbW ) + DiagScanOrder[ log2SbW ][ log2SbH ][ n ][ 0 ] | |
| yC = ( yS << log2SbH ) + DiagScanOrder[ log2SbW ][ log2SbH ][ n ][ 1 ] | |
| if( AbsLevel[ xC ][ yC ] > 0 ) { | |
| TransCoeffLevel[ x0 ][ y0 ][ cIdx ][ xC ][ yC ] = | |
| AbsLevel[ xC ][ yC ] * ( 1 − 2 * coeff_sign_flag[ n ] ) | |
| if( signHiddenFlag ) { | |
| sumAbsLevel += AbsLevel[ xC ][ yC ] | |
| if( ( n = = firstSigScanPosSb ) && ( sumAbsLevel % 2 ) = = 1 ) ) | |
| TransCoeffLevel[ x0 ][ y0 ][ cIdx ][ xC ][ yC ] = | |
| −TransCoeffLevel[ x0 ][ y0 ][ cIdx ][ xC ][ yC ] | |
| } | |
| } | |
| } | |
| } | |
| } | |
| } | |

An example transform unit syntax is as follows.

| | Descriptor |
|---|---|
| transform_unit( x0, y0, tbWidth, tbHeight, treeType, subTuIndex, chType ) { | |
| if( IntraSubPartitionsSplitType != ISP_NO_SPLIT && | |
| treeType = = SINGLE_TREE && subTuIndex = = | |
| NumIntraSubPartitions − 1 ) { | |
| xC = CbPosX[ chType ][ x0 ][ y0 ] | |
| yC = CbPosY[ chType ][ x0 ][ y0 ] | |
| wC = CbWidth[ chType ][ x0 ][ y0 ] / SubWidthC | |
| hC = CbHeight[ chType ][ x0 ][ y0 ] / SubHeightC | |
| } else { | |
| xC = x0 | |
| yC = y0 | |
| wC = tbWidth / SubWidthC | |
| hC = tbHeight / SubHeightC | |
| } | |
| chromaAvailable = treeType != DUAL_TREE_LUMA && | |
| sps_chroma_format_idc != 0 && | |
| ( IntraSubPartitionsSplitType = = ISP_NO_SPLIT \| \| | |
| ( IntraSubPartitionsSplitType != ISP_NO_SPLIT && | |
| subTuIndex = = NumIntraSubPartitions − 1 ) ) | |
| if( ( treeType = = SINGLE_TREE \| \| treeType = = DUAL_TREE_CHROMA ) | |
| && | |
| sps_chroma_format_idc != 0 && | |
| ( ( IntraSubPartitionsSplitType = = ISP_NO_SPLIT && !( cu_sbt_flag && | |
| ( ( subTuIndex = = 0 && cu_sbt_pos_flag ) \| \| | |
| ( subTuIndex = = 1 && !cu_sbt_pos_flag ) ) ) ) \| \| | |
| ( IntraSubPartitionsSplitType != ISP_NO_SPLIT && | |
| ( subTuIndex = = NumIntraSubPartitions − 1 ) ) ) ) { | |
| tu_cb_coded_flag[ xC ][ yC ] | ae(v) |
| tu_cr_coded_flag[ xC ][ yC ] | ae(v) |
| } | |
| if( treeType = = SINGLE_TREE \| \| treeType = = DUAL_TREE_LUMA ) { | |
| if( ( IntraSubPartitionsSplitType = = ISP_NO_SPLIT && !( cu_sbt_flag && | |
| ( ( subTuIndex = = 0 && cu_sbt_pos_flag ) \| \| | |
| ( subTuIndex = = 1 && !cu_sbt_pos_flag ) ) ) && | |
| ( ( CuPredMode[ chType ][ x0 ][ y0 ] = = MODE_INTRA && | |
| !cu_act_enabled_flag[ x0 ][ y0 ] ) \| \| | |
| ( chromaAvailable && ( tu_cb_coded_flag[ xC ][ yC ] \| \| | |
| tu_cr_coded_flag[ xC ][ yC ] ) ) \| \| | |
| CbWidth[ chType ][ x0 ][ y0 ] > MaxTbSizeY | |
| CbHeight[ chType ][ x0 ][ y0 ] > MaxTbSizeY ) ) \| \| | |
| ( IntraSubPartitionsSplitType != ISP_NO_SPLIT && | |
| ( subTuIndex < NumIntraSubPartitions − 1 \| \| !InferTuCbfLuma ) ) ) | |
| tu_y_coded_flag[ x0 ][ y0 ] | ae(v) |
| if(IntraSubPartitionsSplitType != ISP_NO_SPLIT ) | |
| InferTuCbfLuma = InferTuCbfLuma && !tu_y_coded_flag[ x0 ][ y0 ] | |
| } | |
| if( ( CbWidth[ chType ][ x0 ][ y0 ] > 64 \| \| CbHeight[ chType ][ x0 ][ y0 ] > 64 \| \| | |
| tu_y_coded_flag[ x0 ][ y0 ] \| \| ( chromaAvailable && ( | |
| tu_cb_coded_flag[ xC ][ yC ] \| \| | |
| tu_cr_coded_flag[ xC ][ yC ] ) ) && treeType != DUAL_TREE_CHROMA | |
| && | |
| pps_cu_qp_delta_enabled_flag && !IsCuQpDeltaCoded ) { | |
| cu_qp_delta_abs | ae(v) |
| if( cu_qp_delta_abs ) | |
| cu_qp_delta_sign_flag | ae(v) |
| } | |
| if( ( CbWidth[ chType ][ x0 ][ y0 ] > 64 \| \| CbHeight[ chType ][ x0 ][ y0 ] > 64 \| \| | |
| ( chromaAvailable && ( tu_cb_coded_flag[ xC ][ yC ] \| \| | |
| tu_cr_coded_flag[ xC ][ yC ] ) ) ) && | |
| treeType != DUAL_TREE_LUMA && | |
| sh_cu_chroma_qp_offset_enabled_flag && | |
| !IsCuChromaQpOffsetCoded ) { | |
| cu_chroma_qp_offset_flag | ae(v) |
| if( cu_chroma_qp_offset_flag && pps_chroma_qp_offset_list_len_minus1 > 0 ) | |
| cu_chroma_qp_offset_idx | ae(v) |
| } | |
| if( sps_joint_cbcr_enabled_flag && ( ( CuPredMode[ chType ][ x0 ][ y0 ] = = | |
| MODE_INTRA | |
| && ( tu_cb_coded_flag[ xC ][ yC ] \| \| tu_cr_coded_flag[ xC ][ yC ] ) ) \| \| | |
| ( tu_cb_coded_flag[ xC ][ yC ] && tu_cr_coded_flag[ xC ][ yC ] ) ) && | |
| chromaAvailable ) | |
| tu_joint_cbcr_residual_flag[ xC ][ yC ] | ae(v) |
| if( tu_y_coded_flag[ x0 ][ y0 ] && treeType != DUAL_TREE_CHROMA ) { | |
| if( sps_transform_skip_enabled_flag && !BdpcmFlag[ x0 ][ y0 ][ 0 ] && | |
| tbWidth <= MaxTsSize && tbHeight <= MaxTsSize && | |
| ( IntraSubPartitionsSplitType = = ISP_NO_SPLIT ) && !cu_sbt_flag ) | |
| transform_skip_flag[ x0 ][ y0 ][ 0 ] | ae(v) |
| if( !transform_skip_flag[ x0 ][ y0 ][ 0 ] \| \| sh_ts_residual_coding_disabled_flag ) | |
| residual_coding( x0, y0, Log2( tbWidth ), Log2( tbHeight ), 0, treeType ) | |
| else | |
| residual_ts_coding( x0, y0, Log2( tbWidth ), Log2( tbHeight ), 0 ) | |
| } | |
| if( tu_cb_coded_flag[ xC ][ yC ] && treeType != DUAL_TREE_LUMA ) { | |
| if( sps_transform_skip_enabled_flag && !BdpcmFlag[ x0 ][ y0 ][ 1 ] && | |
| wC <= MaxTsSize && hC <= MaxTsSize && !cu_sbt_flag ) | |
| transform_skip_flag[ xC ][ yC ][ 1 ] | ae(v) |
| if( !transform_skip_flag[ xC ][ yC ][ 1 ] \| \| sh_ts_residual_coding_disabled_flag ) | |
| residual_coding( xC, yC, Log2( wC ), Log2( hC ), 1, treeType ) | |
| else | |
| residual_ts_coding( xC, yC, Log2( wC ), Log2( hC ), 1 ) | |
| } | |
| if( tu_cr_coded_flag[ xC ][ yC ] && treeType != DUAL_TREE_LUMA && | |
| !( tu_cb_coded_flag[ xC ][ yC ] && tu_joint_cbcr_residual_flag[ xC ][ yC ] ) ) | |
| { | |
| if( sps_transform_skip_enabled_flag && !BdpcmFlag[ x0 ][ y0 ][ 2 ] && | |
| wC <= MaxTsSize && hC <= MaxTsSize && !cu_sbt_flag ) | |
| transform_skip_flag[ xC ][ yC ][ 2 ] | ae(v) |
| if( !transform_skip_flag[ xC ][ yC ][ 2 ] \| \| sh_ts_residual_coding_disabled_flag ) | |
| residual_coding( xC, yC, Log2( wC ), Log2( hC ), 2, treeType ) | |
| else | |
| residual_ts_coding( xC, yC, Log2( wC ), Log2( hC ), 2 ) | |
| } | |
| } | |

An example residual coding syntax is as follows.

| | Descriptor |
|---|---|
| residual_coding( x0, y0, log2TbWidth, log2TbHeight, cIdx, treeType ) { | |
| if( sps_mts_enabled_flag && cu_sbt_flag && cIdx = = 0 && | |
| log2TbWidth = = 5 && log2TbHeight < 6 ) | |
| log2ZoTbWidth = 4 | |
| else | |
| log2ZoTbWidth = Min( log2TbWidth, 5 ) | |
| if( sps_mts_enabled_flag && cu_sbt_flag && cIdx = = 0 && | |
| log2TbWidth < 6 && log2TbHeight = = 5 ) | |
| log2ZoTbHeight = 4 | |
| else | |
| log2ZoTbHeight = Min( log2TbHeight, 5 ) | |
| if( log2TbWidth > 0 ) | |
| last_sig_coeff_x_prefix | ae(v) |
| if( log2TbHeight > 0 ) | |
| last_sig_coeff_y_prefix | ae(v) |
| if( last_sig_coeff_x_prefix > 3 ) | |
| last_sig_coeff_x_suffix | ae(v) |
| if( last_sig_coeff_y_prefix > 3 ) | |
| last_sig_coeff_y_suffix | ae(v) |
| log2TbWidth = log2ZoTbWidth | |
| log2TbHeight = log2ZoTbHeight | |
| remBinsPass1 = ( ( 1 << ( log2TbWidth + log2TbHeight ) ) * 7 ) >> 2 | |
| log2SbW = ( Min( log2TbWidth, log2TbHeight ) < 2 ? 1 : 2 ) | |
| log2SbH = log2SbW | |
| if( log2TbWidth + log2TbHeight > 3 ) | |
| if( log2TbWidth < 2 ) { | |
| log2SbW = log2TbWidth | |
| log2SbH = 4 − log2SbW | |
| } else if( log2TbHeight < 2 ) { | |
| log2SbH = log2TbHeight | |
| log2SbW = 4 − log2SbH | |
| } | |
| numSbCoeff = 1 << ( log2SbW + log2SbH ) | |
| lastScanPos = numSbCoeff | |
| lastSubBlock = ( 1 << ( log2TbWidth + log2TbHeight − ( log2SbW + log2SbH ) ) | |
| ) − 1 | |
| do { | |
| if( lastScanPos = = 0 ) { | |
| lastScanPos = numSbCoeff | |
| lastSubBlock− − | |
| } | |
| lastScanPos− − | |
| xS = DiagScanOrder[ log2TbWidth − log2SbW ][ log2TbHeight − log2SbH ] | |
| [ lastSubBlock ][ 0 ] | |
| yS = DiagScanOrder[ log2TbWidth − log2SbW ][ log2TbHeight − log2SbH ] | |
| [ lastSubBlock ][ 1 ] | |
| xC = ( xS << log2SbW ) + | |
| DiagScanOrder[ log2SbW ][ log2SbH ][ lastScanPos ][ 0 ] | |
| yC = ( yS << log2SbH ) + | |
| DiagScanOrder[ log2SbW ][ log2SbH ][ lastScanPos ][ 1 ] | |
| } while( ( xC != LastSignificantCoeffX ) \| \| ( yC != LastSignificantCoeffY ) ) | |
| if( lastSubBlock = = 0 && log2TbWidth >= 2 && log2TbHeight >= 2 && | |
| !transform_skip_flag[ x0 ][ y0 ][ cIdx ] && lastScanPos > 0 && (cIdx = = 0 | |
| \| \| treeType != SINGLE_TREE)) | |
| LfnstDcOnly = 0 | |
| if(( ( lastSubBlock > 0 && log2TbWidth >= 2 && log2TbHeight >= 2 ) \| \| | |
| ( lastScanPos > 7 && ( log2TbWidth = = 2 \| \| log2TbWidth = = 3 ) && | |
| log2TbWidth = = log2TbHeight ) ) && (cIdx = = 0 \| \| treeType != | |
| SINGLE_TREE)) | |
| LfnstZeroOutSigCoeffFlag = 0 | |
| if( ( lastSubBlock > 0 \| \| lastScanPos > 0 ) && cIdx = = 0 ) | |
| MtsDcOnly = 0 | |
| QState = 0 | |
| for( i = lastSubBlock; i >= 0; i− − ) { | |
| startQStateSb = QState | |
| xS = DiagScanOrder[ log2TbWidth − log2SbW ][ log2TbHeight − log2SbH ] | |
| [ i ][ 0 ] | |
| yS = DiagScanOrder[ log2TbWidth − log2SbW ][ log2TbHeight − log2SbH ] | |
| [ i ][ 1 ] | |
| inferSbDcSigCoeffFlag = 0 | |
| if( i < lastSubBlock && i > 0 ) { | |
| sb_coded_flag[ xS ][ yS ] | ae(v) |
| inferSbDcSigCoeffFlag = 1 | |
| } | |
| if( sb_coded_flag[ xS ][ yS ] && ( xS > 3 \| \| yS > 3 ) && cIdx = = 0 ) | |
| MtsZeroOutSigCoeffFlag = 0 | |
| firstSigScanPosSb = numSbCoeff | |
| lastSigScanPosSb = −1 | |
| firstPosMode0 = ( i = = lastSubBlock ? lastScanPos : numSbCoeff − 1 ) | |
| firstPosMode1 = firstPosMode0 | |
| for( n = firstPosMode0; n >= 0 && remBinsPass1 >= 4; n− − ) { | |
| xC = ( xS << log2SbW ) + DiagScanOrder[ log2SbW ][ log2SbH ][ n ][ 0 ] | |
| yC = ( yS << log2SbH ) + DiagScanOrder[ log2SbW ][ log2SbH ][ n ][ 1 ] | |
| if( sb_coded_flag[ xS ][ yS ] && ( n > 0 \| \| !inferSbDcSigCoeffFlag ) && | |
| ( xC != LastSignificantCoeffX \| \| yC != Last SignificantCoeffY ) ) { | |
| sig_coeff_flag[ xC ][ yC ] | ae(v) |
| remBinsPass1− − | |
| if( sig_coeff_flag[ xC ][ yC ] ) | |
| inferSbDcSigCoeffFlag = 0 | |
| } | |
| if( sig_coeff_flag[ xC ][ yC ] ) { | |
| abs_level_gtx_flag[ n ][ 0 ] | ae(v) |
| remBinsPass1− − | |
| if( abs_level_gtx_flag[ n ][ 0 ] ) { | |
| par_level_flag[ n ] | ae(v) |
| remBinsPass 1− − | |
| abs_level_gtx_flag[ n ][ 1 ] | ae(v) |
| remBinsPass 1− − | |
| } | |
| if( lastSigScanPosSb = = −1 ) | |
| lastSigScanPosSb = n | |
| firstSigScanPosSb = n | |
| } | |
| AbsLevelPass1[ xC ][ yC ] = sig_coeff_flag[ xC ][ yC ] + par_level_flag[ n ] + | |
| abs_level_gtx_flag[ n ][ 0 ] + 2 * abs_level_gtx_flag[ n ][ 1 ] | |
| if( sh_dep_quant_used_flag ) | |
| QState = QStateTransTable[ QState ][ AbsLevelPass1[ xC ][ yC ] & 1 ] | |
| firstPosMode1 = n − 1 | |
| } | |
| for( n = firstPosMode0; n > firstPosMode1; n− − ) { | |
| xC = ( xS << log2SbW ) + DiagScanOrder[ log2SbW ][ log2SbH ][ n ][ 0 ] | |
| yC = ( yS << log2SbH ) + DiagScanOrder[ log2SbW ][ log2SbH ][ n ][ 1 ] | |
| if( abs_level_gtx_flag[ n ][ 1 ] ) | |
| abs_remainder[ n ] | ae(v) |
| AbsLevel[ xC ][ yC ] = AbsLevelPass1[ xC ][ yC ] +2 * abs_remainder[ n ] | |
| } | |
| for( n = firstPosMode1; n >= 0; n− − ) { | |
| xC = ( xS << log2SbW ) + DiagScanOrder[ log2SbW ][ log2SbH ][ n ][ 0 ] | |
| yC = ( yS << log2SbH ) + DiagScanOrder[ log2SbW ][ log2SbH ][ n ][ 1 ] | |
| if( sb_coded_flag[ xS ][ yS ] ) | |
| dec_abs_level[ n ] | ae(v) |
| if( AbsLevel[ xC ][ yC ] > 0 ) { | |
| if( lastSigScanPosSb = = −1 ) | |
| lastSigScanPosSb = n | |
| firstSigScanPosSb = n | |
| } | |
| if( sh_dep_quant_used_flag ) | |
| QState = QStateTransTable[ QState ][ AbsLevel[ xC ][ yC ] & 1 ] | |
| } | |
| signHiddenFlag = sh_sign_data_hiding_used_flag && | |
| ( lastSigScanPosSb − firstSigScanPosSb > 3 ? 1 : 0 ) | |
| for( n = numSbCoeff − 1; n >= 0; n− − ) { | |
| xC = ( xS << log2SbW ) + DiagScanOrder[ log2SbW ][ log2SbH ][ n ][ 0 ] | |
| yC = ( yS << log2SbH ) + DiagScanOrder[ log2SbW ][ log2SbH ][ n ][ 1 ] | |
| if( ( AbsLevel[ xC ][ yC ] > 0 ) && | |
| ( !signHiddenFlag \| \| ( n != firstSigScanPosSb ) ) ) | |
| coeff_sign_flag[ n ] | ae(v) |
| } | |
| if( sh_dep_quant_used_flag ) { | |
| QState = startQStateSb | |
| for( n = numSbCoeff − 1; n >= 0; n− − ) { | |
| xC = ( xS << log2SbW ) + DiagScanOrder[ log2SbW ][ log2SbH ][ n ][ 0 ] | |
| yC = ( yS << log2SbH ) + DiagScanOrder[ log2SbW ][ log2SbH ][ n ][ 1 ] | |
| if( AbsLevel[ xC ][ yC ] > 0 ) | |
| TransCoeffLevel[ x0 ][ y0 ][ cIdx ][ xC ][ yC ] = | |
| ( 2 * AbsLevel[ xC ][ yC ] − ( QState > 1 ? 1 : 0 ) ) * | |
| ( 1 − 2 * coeff_sign_flag[ n ] ) | |
| QState = QStateTransTable[ QState ][ AbsLevel[ xC ][ yC ] & 1 ] | |
| } else { | |
| sumAbsLevel = 0 | |
| for( n = numSbCoeff − 1; n >= 0; n− − ) { | |
| xC = ( xS << log2SbW ) + DiagScanOrder[ log2SbW ][ log2SbH ][ n ][ 0 ] | |
| yC = ( yS << log2SbH ) + DiagScanOrder[ log2SbW ][ log2SbH ][ n ][ 1 ] | |
| if( AbsLevel[ xC ][ yC ] > 0 ) { | |
| TransCoeffLevel[ x0 ][ y0 ][ cIdx ][ xC ][ yC ] = | |
| AbsLevel[ xC ][ yC ] * ( 1 − 2 * coeff_sign_flag[ n ] ) | |
| if( signHiddenFlag ) { | |
| sumAbsLevel += AbsLevel[ xC ][ yC ] | |
| if( ( n = = firstSigScanPosSb ) && ( sumAbsLevel % 2 ) = = 1 ) ) | |
| TransCoeffLevel[ x0 ][ y0 ][ cIdx ][ xC ][ yC ] = | |
| −TransCoeffLevel[ x0 ][ y0 ][ cIdx ][ xC ][ yC ] | |
| } | |
| } | |
| } | |
| } | |
| } | |
| } | |

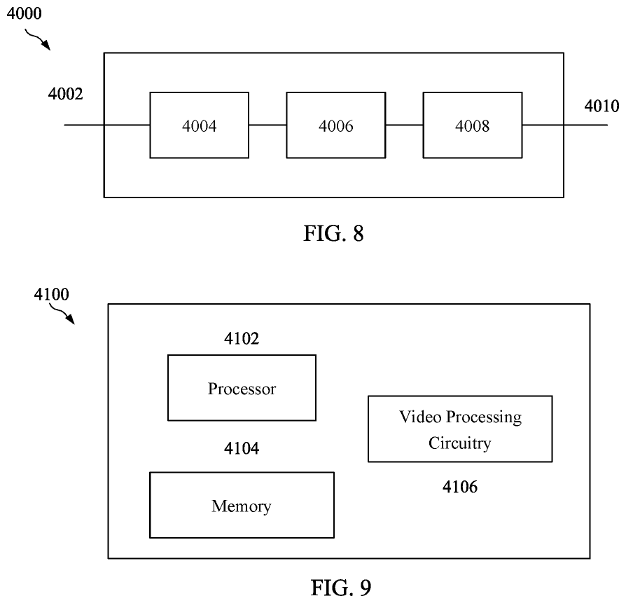

FIG. 8 is a block diagram showing an example video processing system 4000 in which various techniques disclosed herein may be implemented. Various implementations may include some or all of the components of the system 4000. The system 4000 may include input 4002 for receiving video content. The video content may be received in a raw or uncompressed format, e.g., 8 or 10 bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as Wi-Fi or cellular interfaces.

The system 4000 may include a coding component 4004 that may implement the various coding or encoding methods described in the present document. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or Displayport, and so on. Examples of storage interfaces include SATA (serial advanced technology attachment), PCI, IDE interface, and the like. The techniques described in the present document may be embodied in various electronic devices such as mobile phones, laptops, smartphones or other devices that are capable of performing digital data processing and/or video display.

FIG. 9 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present document. The memory (memories) 4104 may be used for storing data and code used for implementing the methods and techniques described herein. The video processing circuitry 4106 may be used to implement, in hardware circuitry, some techniques described in the present document. In some embodiments, the video processing circuitry 4106 may be at least partly included in the processor 4102, e.g., a graphics co-processor.

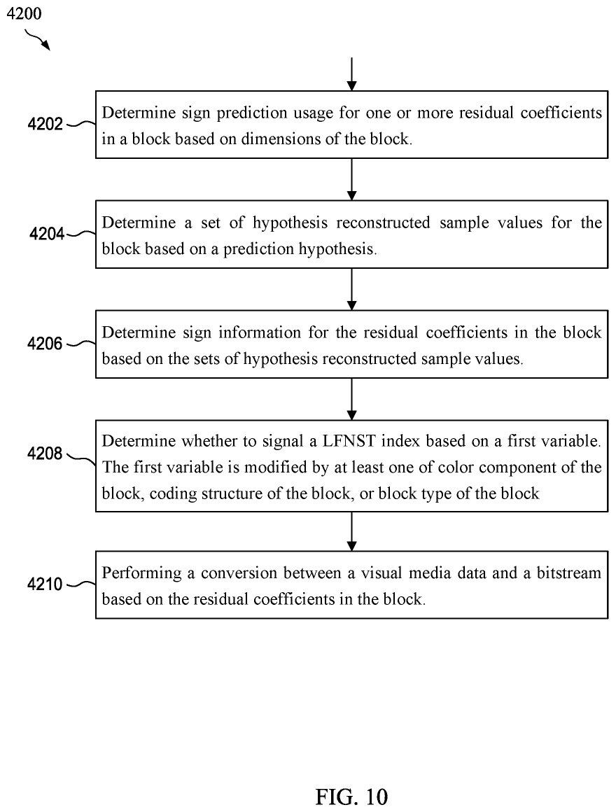

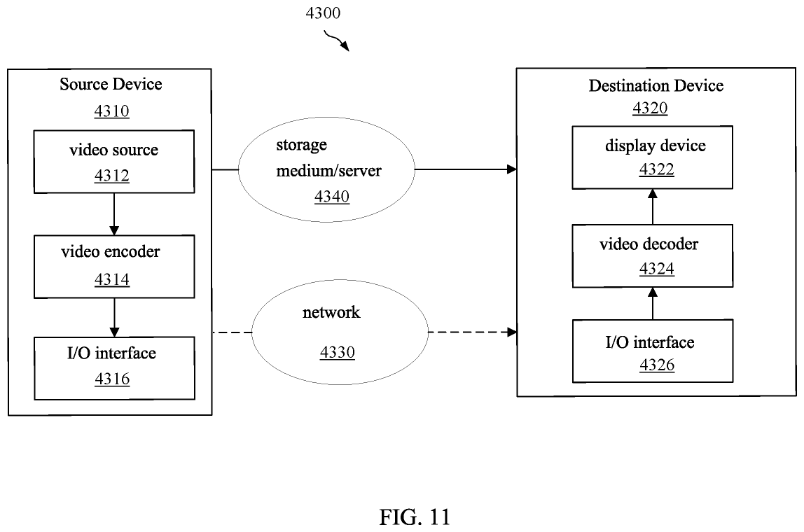

FIG. 10 is a flowchart for an example method 4200 of video processing. The method 4200 includes determining sign prediction usage for one or more residual coefficients in a block based on dimensions of the block at step 4202. In an example, sign prediction can be disallowed for the block when the block is non-dyadic. In an example, sign prediction can be applied to a dyadic sized set of the residual coefficients in the block when the block is non-dyadic. In an example, sign prediction can be disallowed for the block when a dimension of the block is not evenly divisible by M, where M is an integer value. In an example, sign prediction can be disallowed for the block when a dimension of the block is equal to M, where M is an integer value. In an example, syntax element(s) describing sign prediction for the block can be omitted from a bitstream when sign prediction is disallowed for the block.

In an example, a maximum number of predicted signs can be determined based on a location of the block, a block dimension, a block type, or combinations thereof. In an example, sign prediction is determined based on coding information including a QP, a prediction mode, a coding tool, motion information, a color component, a color format, a temporal layer, a slice type, a neighboring block information, a coding tree depth, the residual coefficients of the block, a transform type, a residual coding mode, a partition tree type, or combinations thereof.

When sign prediction is allowed, a set of hypothesis reconstructed sample values for the block are determined based on a prediction hypothesis at step 4204. The block has dimensions including a width (W) and a height (H). In an example, at least one of W or H is non-dyadic. In an example, the set hypothesis reconstructed sample values for the block can be determined based on a pattern of the residual coefficients in the block. In an example, determining the set of hypothesis reconstructed sample values includes determining a first set of hypothesis reconstructed sample values and determining a second set of hypothesis reconstructed sample values. Each set of hypothesis reconstructed sample values may correspond to a specific residual coefficient. In an example, the first set of hypothesis reconstructed sample values and the second set of hypothesis reconstructed sample values are collectively used to determine a cost for the pattern of the residual coefficients in the block. In an example, a first table can be used to store all sets of hypothesis reconstructed sample values in entries. Further, a second table may be used to indicates indices for the entries in the first table.

At step 4206, sign information for the residual coefficients in the block are determined based on the sets of hypothesis reconstructed sample values. In an example, the block includes a first sign for a first residual coefficient and a second sign for a second residual coefficient. The first sign can be predicted according to a first rule and the second sign can be is predicted according to a second rule that is different from the first rule. In an example, a prediction of the second sign is dependent of a prediction of the first sign.

At step 4208, whether to signal a LFNST index is determined based on a first variable. For example, the first variable can be modified by at least one of color component of the block, coding structure of the block, or block type of the block. In an example, the first variable is a LfnstDcOnly flag or a LfnstZeroOutSigCoeffFlag. In an example, the first variable is dependent on a transform skip flag. In an example, the first variable is not modified when parsing a residual block of a first color component when single-tree coding structure is applied. In an example, the first variable is modified when parsing a residual block of a first color component when a dual-tree coding structure is applied. In an example, the first variable is modified when parsing a residual block of a first color component when a dual-tree coding structure is applied. In an example, the determination whether to signal the LFNST index is based on a modified value in the first variable.

At step 4210, a conversion is performed between a visual media data and a bitstream based on the residual coefficients in the block. When the method 4200 is performed on an encoder, the conversion comprises generating the bitstream according to the visual media data. The conversion includes determining and encoding sign prediction and/or LFNST related information into the bitstream. When the method 4200 is performed on a decoder, the conversion comprises parsing and decoding the bitstream to obtain the video units in the visual media data. The sign predication and/or LFNST information is read from the bitstream. The decoder can then determine residual samples based on the sign prediction, the LFNST, and differences between the samples reconstructed according to the predicted sign and the original samples. The decoder can reconstruct the samples based on the residual and prediction from the bitstream.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

FIG. 11 is a block diagram that illustrates an example video coding system 4300 that may utilize the techniques of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVM) standard and other current and/or further standards.

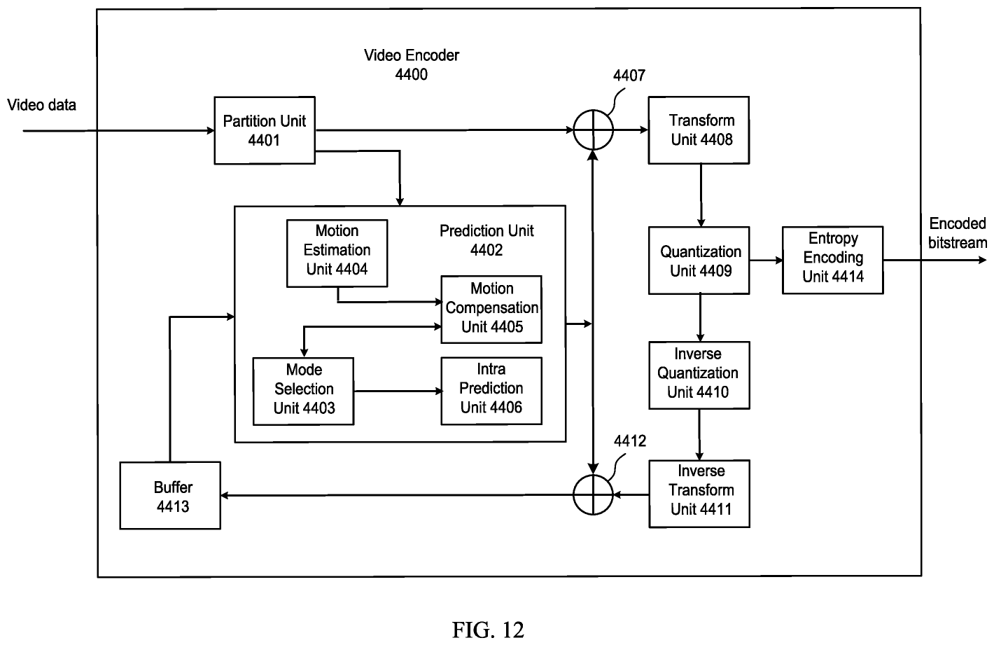

FIG. 12 is a block diagram illustrating an example of video encoder 4400, which may be video encoder 4314 in the system 4300 illustrated in FIG. 11. Video encoder 4400 may be configured to perform any or all of the techniques of this disclosure. The video encoder 4400 includes a plurality of functional components. The techniques described in this disclosure may be shared among the various components of video encoder 4400. In some examples, a processor may be configured to perform any or all of the techniques described in this disclosure.

The functional components of video encoder 4400 may include a partition unit 4401, a prediction unit 4402 which may include a mode select unit 4403, a motion estimation unit 4404, a motion compensation unit 4405, an intra prediction unit 4406, a residual generation unit 4407, a transform processing unit 4408, a quantization unit 4409, an inverse quantization unit 4410, an inverse transform unit 4411, a reconstruction unit 4412, a buffer 4413, and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

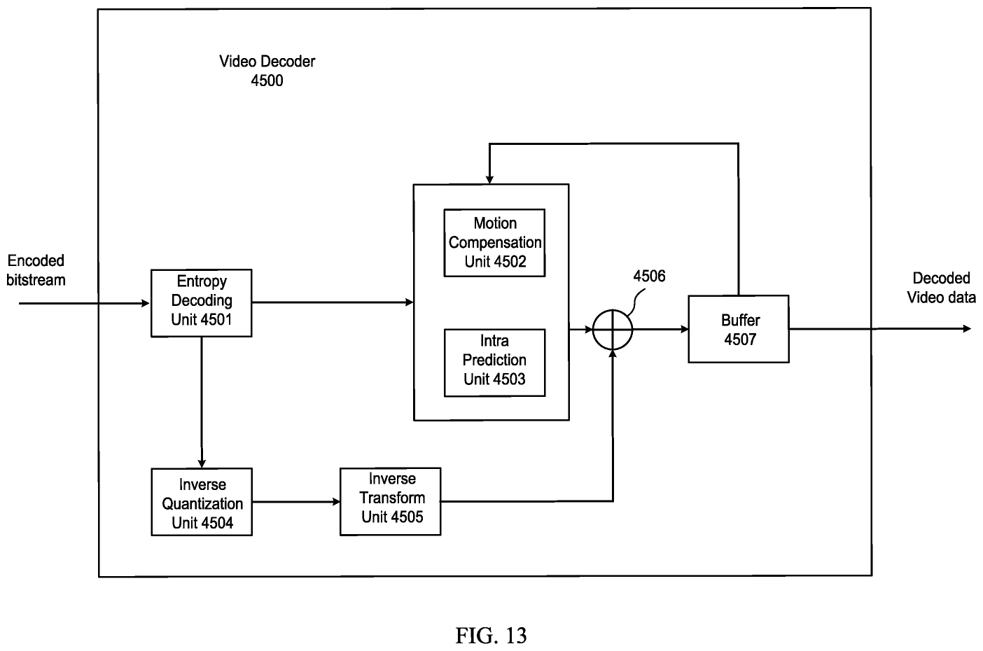

FIG. 13 is a block diagram illustrating an example of video decoder 4500 which may be video decoder 4324 in the system 4300 illustrated in FIG. 11. The video decoder 4500 may be configured to perform any or all of the techniques of this disclosure. In the example shown, the video decoder 4500 includes a plurality of functional components. The techniques described in this disclosure may be shared among the various components of the video decoder 4500. In some examples, a processor may be configured to perform any or all of the techniques described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

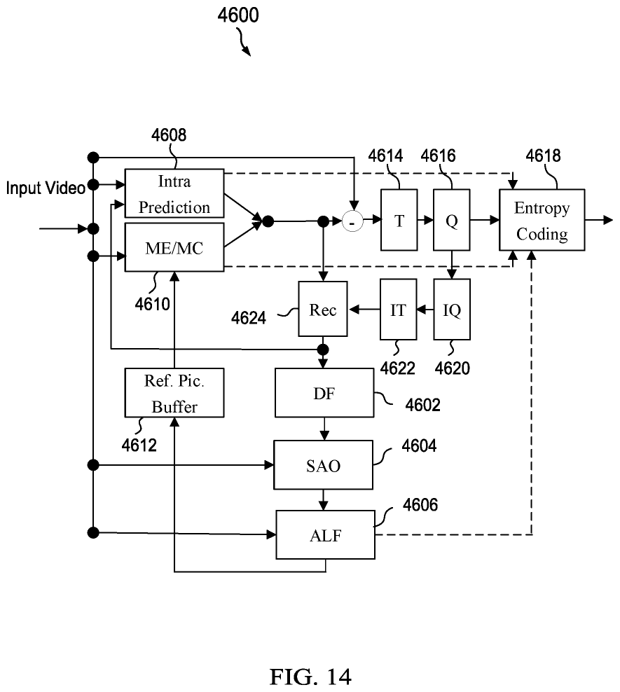

FIG. 14 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612. A listing of solutions preferred by some examples is provided next.

The following solutions show examples of techniques discussed herein.

1. A method of video processing (e.g., method 4200 shown in FIG. 10), comprising: performing a conversion between a video block of a video and a bitstream of the video according to a rule; wherein the rule specifies that whether a syntax element indicative of use of a low frequency non-separable transform is applied to the video block depends on a coding condition associated with the video block that is indicated by a variable.

2. The method of solution 1, wherein the coding condition includes a color component of the video block.

3. The method of any of solutions 1-2, wherein the coding condition includes a coding structure of the video block.

4. The method of any of solutions 1-2, wherein the coding condition includes a type of the block.

5. The method of solution 4, wherein the type of the block is one of dyadic or non-dyadic.

6. The method of any of solutions 1-5, wherein the coding condition is related to a range of non-zero coefficients in a residual block corresponding to the video block.

7. The method of any of solutions 1-6, wherein the coding condition relates to whether the video block is coded by skipping a non-identity transform operation.

8. A method of video processing, comprising: determining, for a conversion between a video block of a video and a bitstream representation of the video, whether a sign prediction of the video block is enabled according to a rule; and performing the conversion according to the determining; wherein the rule is based on a dimension of the video block of a coding information of the video block.

9. The method of solution 8, wherein the rule defines that the sign prediction is disabled responsive to the dimension being non-dyadic.

10. The method of solution 8, wherein the rule defines that the sign prediction is disabled in case that W % M !=0 and/or H % M !=0, where W is a width of the video block in samples, H is a height of the video block in samples and M is an integer.

11. The method of any of solutions 8-10, wherein the rule specifies that a syntax element related to the sign prediction is indicated based on the dimension.

12. The method of solution 8, wherein the coding information comprises a quantization parameter of the video block or a coding mode of the video block or a transform type of the video block or a partition type of the video block.

13. A method of video processing, comprising: storing, for a conversion between a video block of a video and a bitstream of the video K sets of hypothesis corresponding to N reconstructed samples at top or left boundaries of the video block, wherein the video block has a dimension W x H; and performing the conversion based on the N hypothesis.

14. The method of solution 13, wherein N=W+H−1.

15. The method of any of solutions 13-14, wherein the W or H is non-dyadic.

16. The method of any of solutions 13-15, wherein K is greater than 1.

17. The method of any of solutions 13-16, wherein the stored samples are used to derive sign information for the video block.

18. A method of video processing, comprising: performing, for a conversion between a video block of a video and a bitstream of the video, predictions of signs of one or more coefficients of the video block according to a rule; and using the prediction for the conversion.

19. The method of solution 18, wherein the rule specifies that different calculation rules are applied to different positions of samples within the video block.

20. The method of any of solutions 18-19, wherein the rule defines that a first prediction of sign of a first coefficient depends on a predicted sign for a second coefficient in the video block.

21. The method of solution 18, wherein the rule specifies a number of signs that are predicted for the video block according to a coding condition of the video block.

22. The method of solution 21, wherein the coding condition corresponds to whether the video block is at a boundary of a video region, wherein the video region is a picture or a slice.

23. The method of solution 21, wherein the coding condition comprises a quantization parameter of the video block or a prediction mode of the video block or a transform type applied to the video block or a partitioning mode of the video block.

24. The method of any of solutions 1-23, wherein the video block comprises a coding block, a transform block, a prediction block, a coding tree unit, a coding tree unit row or a slice.

25. The method of any of solutions 1-24, wherein the conversion comprises generating the video from the bitstream or generating the bitstream from the video.

26. A method of storing a bitstream on a computer-readable medium, comprising generating a bitstream according to a method recited in any one or more of solutions 1-25 and storing the bitstream on the computer-readable medium.

27. A computer-readable medium having a bitstream of a video stored thereon, the bitstream, when processed by a processor of a video decoder, causing the video decoder to generate the video, wherein the bitstream is generated according to a method recited in one or more of solutions 1 to 26.

28. A video decoding apparatus comprising a processor configured to implement a method recited in one or more of solutions 1 to 26.

29. A video encoding apparatus comprising a processor configured to implement a method recited in one or more of solutions 1 to 26.

30. A computer program product having computer code stored thereon, the code, when executed by a processor, causes the processor to implement a method recited in any of solutions 1 to 26.

31. A computer readable medium on which a bitstream complying to a bitstream format that is generated according to any of solutions 1 to 26.

32. A method, an apparatus, a bitstream generated according to a disclosed method or a system described in the present document.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present document, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While this patent document contains many specifics, these should not be construed as limitations on the scope of any subject matter or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method of processing video data, comprising:
determining, for a conversion between a video block of a video and a bitstream of the video, whether a sign prediction is applied for one or more residual coefficients in the video block based on a rule; and
performing the conversion based on the determining,
wherein the rule specifies that whether the sign prediction is applied for one or more residual coefficients in the video block is based on coding information for the video block.

2. The method of claim 1, wherein the coding information comprises a transform type for the video block.

3. The method of claim 2, wherein the sign prediction is allowed for the video block, in a case that the transform type for the video block is a low frequency non-separable transform (LFNST).

4. The method of claim 3, wherein for the video block coded using the low frequency non-separable transform (LFNST), a maximum of 4 residual coefficients of the video block are allowed to be sign predicted.

5. The method of claim 1, wherein the rule further specifies that a maximum area for the sign prediction is determined based on at least one of configuration, a quantization parameter (QP), and a sequence class, or
the maximum area for the sign prediction is signaled at a sequence parameter set (SPS) level in the bitstream.

6. The method of claim 3, wherein whether a first syntax element indicative of a use of the low frequency non-separable transform (LFNST) being included in the bitstream depends on a value of a first variable,
wherein the value of the first variable is determined based on at least one of a color component, a coding structure, or a type for the video block, and
wherein the type for the video block is dyadic or non-dyadic.

7. The method of claim 6, wherein the first variable indicates whether there is only one DC non-zero coefficient in a residual block corresponding to the video block,
the first variable indicates a range of non-zero coefficients in a residual block corresponding to the video block, or
the first variable indicates whether a transform is applied to the video block or not.

8. The method of claim 1, wherein the coding information comprises at least one of a quantization parameter (QP), a prediction mode, a coding tool, motion information, a color component, a color format, a temporal layer, a slice type, information of a neighboring block for the video block, a coding tree depth, a residual coefficient of the video block, a residual coefficient coding mode, or a tree type.

9. The method of claim 8, wherein in a case that a number of non-zero coefficients in the video block is no greater than a first threshold, the sign prediction is disabled for the video block;
in a case that the number of non-zero coefficients in the video block is no smaller than a second threshold, the sign prediction is disabled for the video block;
in a case that the video block is coded using a transform skip mode, the sign prediction is disabled for the video block;
in a case that the video block is coded using a transform skip based residual coding (TSRC) tool, the sign prediction is disabled for the video block;
in a case that the video block is coded using a joint coding of chroma residuals (JCCR) tool, the sign prediction is disabled for the video block;
in a case that the video block has a tree type of dual tree, the sign prediction is disabled for the video block; and
in a case that the video block has a tree type of local dual tree, the sign prediction is disabled for the video block.

10. The method of claim 1, wherein the rule further specifies that whether the sign prediction is applied for one or more residual coefficients in the video block is based on dimensions of the video block,
in a case that the video block has a dimension of W×H where at least one of W or H is a non-dyadic number, the sign prediction is allowed for a subset of the one or more residual coefficients in the video block,
wherein the subset of the one or more residual coefficients in the video block has a dimension of M×N, and
wherein M is a dyadic number less than W, or N is a dyadic number less than H.

11. The method of claim 10, wherein the rule further specifies that the sign prediction is not applied for the one or more residual coefficients in the video block, in a case that the video block has a dimension of W×H where W and H are integers,
wherein at least one of W or H is not evenly divisible by a first value, and the first value is 4 or 8, or
wherein at least one of W or H is equal to a second value, and the second value is 3 or 7.

12. The method of claim 10, wherein a second syntax element indicative of a used of the sign prediction for the video block is omitted from the bitstream in a case that the sign prediction is disabled for the video block,
wherein the video block is a coding unit, a transform unit, a coding block, or a transform block, or
wherein the rule further specifies that whether the sign prediction is applied for a chroma component of the video block is based on dimensions of a luma component of the video block.

13. The method of claim 1, further comprising:
storing a first set of hypothesis reconstructed samples for the video block based on a first prediction hypothesis,
wherein the video block has a dimension of W×H where at least one of W or H is a non-dyadic number, and
wherein a number of the first set of hypothesis reconstructed samples is equal to W+H−1.

14. The method of claim 13, wherein the first set of hypothesis reconstructed samples for the video block are determined based on a pattern of the one or more residual coefficients in the video block, and
wherein a first table is used to store the first set of hypothesis reconstructed samples, and a second table is used to derive an index indicative an entry in the first table.

15. The method of claim 13, further comprising:
storing a second set of hypothesis reconstructed samples for the video block based on a second prediction hypothesis,
wherein a number of the second set of hypothesis reconstructed samples is equal to W+H−1,
wherein each of the first set of hypothesis reconstructed samples and the second set of hypothesis reconstructed samples corresponds to a specific residual coefficient whose sign value has been predicted, and
wherein the first set of hypothesis reconstructed samples and the second set of hypothesis reconstructed samples are used to determine a cost for a pattern of predicted signs for the video block.

16. The method of claim 1, wherein the conversion includes encoding the video block into the bitstream.

17. The method of claim 1, wherein the conversion includes decoding the video block from the bitstream.

18. An apparatus for processing video data comprising a processor and a non-transitory memory with instructions thereon, wherein the instructions upon execution by the processor cause the processor to:
determine, for a conversion between a video block of a video and a bitstream of the video, whether a sign prediction is applied for one or more residual coefficients in the video block based on a rule; and
perform the conversion based on the determining,
wherein the rule specifies that whether the sign prediction is applied for one or more residual coefficients in the video block is based on coding information for the video block.

19. A non-transitory computer-readable storage medium storing instructions that cause a processor to:
determine, for a conversion between a video block of a video and a bitstream of the video, whether a sign prediction is applied for one or more residual coefficients in the video block based on a rule; and
perform the conversion based on the determining,
wherein the rule specifies that whether the sign prediction is applied for one or more residual coefficients in the video block is based on coding information for the video block.

20. A non-transitory computer-readable recording medium storing a bitstream of a video which is generated by a method performed by a video processing apparatus, wherein the method comprises:
determining, for a video block of the video, whether a sign prediction is applied for one or more residual coefficients in the video block based on a rule; and
generating the bitstream of the video based on the determining,
wherein the rule specifies that whether the sign prediction is applied for one or more residual coefficients in the video block is based on coding information for the video block.
